(19) United States
(12) Patent Application Publication
(10) Pub. No.: US 2025/0149601 A1
(43) Pub. Date: May 8, 2025

(54) CATALYSTS AND METHODS FOR MAKING AND USING THE SAME

(71) Applicant: The Regents of the University of California, Oakland, CA (US)

(72) Inventors: Shaowei Chen, Santa Cruz, CA (US); Bingzhang Lu, Santa Cruz, CA (US); Qiming Liu, Santa Cruz, CA (US)

(21) Appl. No.: 18/727,834

(22) PCT Filed: Jan. 4, 2023
(86) PCT No.: PCT/US2023/010098

§ 371 Date: Jul. 10, 2024

Related U.S. Application Data
(60) Provisional application No. 63/331,415, filed on Apr. 15, 2022.
(60) Provisional application No. 63/298,760, filed on Jan. 12, 2022.

(51) Int. Cl. H01M 4/90; C01G 53/40; C25B 11/052; C25B 11/065; C25B 11/077; H01M 4/92

(52) U.S. Cl. CPC H01M 4/9083; C01G 53/40; C25B 11/052; C25B 11/065; C25B 11/0771; H01M 4/9016; H01M 4/926; C01P 2002/32; C01P 2002/85; C01P 2004/04

(57) ABSTRACT

A method for making a catalyst composition is disclosed. The method includes placing a substrate with at least one precursor composition disposed thereon in contact with a ferromagnetic material and placing the substrate and the ferromagnetic material within an induction solenoid. The method further includes generating an alternating magnetic field within the induction solenoid upon energization by a power source supplying alternating current, thereby heating the substrate and the ferromagnetic material to a temperature of from about 200 c to about 1,500 c. The method additionally includes rapidly cooling the substrate and the ferromagnetic material

### CROSS-REFERENCE TO RELATED APPLICATION

The present application claims the benefit of and priority to U.S. Provisional Application No. 63/298,760, filed on Jan. 12, 2022, and U.S. Provisional Application No. 63/331,415, filed on Apr. 15, 2022. The entire disclosures of each of the foregoing applications are incorporated by reference herein.

### GOVERNMENT LICENSE RIGHTS

This invention was made with Government support under Grant No. CHE-1900235 and CHE-2003685 awarded by the National Science Foundation. The Government has certain rights in the invention.

### BACKGROUND

With the increasing need for energy and rapid depletion of traditional fossil fuels, hydrogen gas (H₂) has been considered as one of the most promising green energy resources. However, currently H₂ is mostly produced by steam-methane reforming at high temperatures (700˜1000° C.), making it energy- and capital-consuming. Electrochemical water splitting (i.e., water electrolysis) represents an effective alternative, where H₂ is produced at the cathode using electricity produced from a sustainable source such as wind, sun light, and hydraulics. An appropriate catalyst is needed to catalyze the hydrogen evolution reaction (HER) so as to decrease the overpotential and increase the current density. Platinum (Pt)-based nanoparticles have remained the catalysts of choice towards HER, yet the high cost and limited natural abundance has hampered the wide-spread applications.

Carbon-based nanocomposites are attracting particular attention as high-performance, low-cost electrocatalysts for electrochemical water splitting. In particular, carbon-based nanocomposites have been hailed as viable catalysts for fuel cells and water electrolyzers. These materials are typically prepared via the pyrolysis and hydrothermal processes. While these methods are rather simple and effective in sample synthesis, they are energy and time-consuming, and the slow heating ramp makes it difficult to produce a non-equilibrium phase in the samples, which is critical in regulating the electronic structure, and hence, the electrocatalytic activity. A range of effective strategies have emerged recently, such as carbothermal shock, flash joule heating, laser ablation, and laser scribing. Despite the progress, the toolbox for such sample synthesis has been limited, and the range of materials that can be produced and the extent of structural engineering remain narrow. Further development of effective protocols for the synthesis of materials with unprecedented structures and properties is of both fundamental and technological significance. Thus, there is a need for HER catalysts that are cheaper and more-environmentally friendly than currently available Pt-based catalysts.

### SUMMARY

The present disclosure provides a novel method for preparing nanocomposites using magnetic induction heating/rapid quenching (MIHRQ). The nanocomposites may be carbon-iron (Fe)-nickel (Ni) spinel oxide or ruthenium (Ru) nanocomposites. The Fe—Ni nanocomposites exhibit a mixing of the Ni and Fe phases and a Cl-rich surface, in contrast to the conventional nanocomposite prepared by prolonged heating and/or natural cooling to the ambient temperature.

The disclosed process includes rapid heating and quenching of Ni and Fe precursors (e.g., at a temperature rate of change of up to 10³ K s⁻¹), which impedes the Ni and Fe phase segregation in FeNi spinels and produces a chloride (Cl)-rich surface thereon. Both of these properties contribute to the remarkable catalytic activity of the catalyst composition. The present disclosure also provides examples illustrating the unique advantage of rapid heating/quenching in the structural engineering of functional nanocomposites to achieve high electrocatalytic performance towards important electrochemical reactions.

In electrochemical measurements, the disclosed nanocomposites display an outstanding electrocatalytic performance towards oxygen evolution reaction (OER), with an ultralow overpotential of about 260 mV to reach the high current density of 100 mA cm⁻². The overpotential at this chosen current density was used to quantify and compare the OER activity—the lower the better. Comparison can also be made based on the overpotentials at other current densities (e.g., 10 mA cm⁻², 50 mA cm⁻², etc.).

This is due to the formation of a metastable structure that is optimal for the adsorption of key OER intermediates and eventual production of oxygen. In electrochemical water splitting, OER has been recognized as a major bottleneck that limits the overall performance because of complex reaction pathways and sluggish electron-transfer kinetics, and FeNi spinel oxides provide a viable alternative to the traditional, noble metal-based commercial catalysts, where manipulation of the occupation of the e_{g} orbitals of the octahedral metals and/or metal-oxygen covalency represent the leading strategies for further enhancement of the OER activity. This may be achieved by engineering the spinel components using heterometal doping and introduction of oxygen vacancies. Phase segregation of Fe and Ni in the spinels is believed to be the leading cause of the apparent loss of the electrocatalytic activity. Moreover, such segregation is inevitable for samples prepared via a conventional thermal process as it is energetically favorable. In addition, residual heteroanions (e.g., Cl) adsorbed on or doped into the surface of Fe, cobalt (Co) and Ni (hydro/oxyhydro) oxides also play a significant role in OER electrocatalysis. Yet the impacts of such anion impurities have remained largely ignored, although most pyrolytically prepared spinel oxides are derived from iron and nickel chlorides. Thus, appropriate synthetic methods of the present disclosure allow for production of such metastable structures with reduced phase segregation and a remarkable concentration of anion impurities.

Ru provides a competitive alternative for platinum towards HER, a critical process in electrochemical water splitting. Ru costs about half of Pt and has emerged as a viable substitute, due to its similar bonding strength with hydrogen (˜65 kcal mol⁻¹) to that of Pt—H, a critical parameter in dictating the HER activity. However, previous studies have indicated Ru's being less suitable as a catalyst when compared to Pt. In the well-known volcano-shaped plot of hydrogen adsorption Gibbs free energy (ΔG_{H*}), Ru is actually situated on the left side, suggesting a somewhat strong adsorption of H that is unfavorable for H desorption from the catalyst surface. Computational studies based on density functional theory (DFT) have shown that H adsorption onto the top sites of Ru(0001) facet possesses an almost ideal ΔG_{H*} of only −0.07 eV, in comparison to the adjacent hollow Ru₃ sites that exhibit a far more negative ΔG_{H*} of approximately −0.45 eV, suggesting that the latter is actually the most likely dominant binding sites, leading to a nonideal HER performance. In addition, effect of ruthenium crystallinity on the HER activity has also been shown as being ineffective in diminishing ΔG_{H*} for optimal HER. It was previously observed that the ΔG_{H*} on the hollow or bridge sites on most facets of hexagonal closed pack (hcp) Ru and face centered cubic (fcc) Ru all ranged from −0.5 to −0.7 eV, markedly greater than that on Pt(111) (approximately 0 eV).

The present disclosure provides a novel method based on magnetic induction heating and rapid quenching (MIHRQ) to synthesize Ru nanoparticles supported on carbon paper within seconds. Notably, in the ultrafast heating-quench process, metallic Ru nanoparticles were generated and deposited evenly on carbon paper by thermal decomposition of RuCl₃ salt even in the ambient atmosphere. Because of the short heating duration, RuCl₃ was incompletely decomposed, leading to residual Cl on the surface of Ru nanoparticles with the Cl content being controlled by adjusting magnetic current and heating time and directly related to the HER performance of the nanoparticles. The examples of the present disclosure confirmed in DFT studies where the Cl species influenced the electronic structure of metallic Ru and the adsorption configuration and energetics of H*. Among the series, the best sample was obtained with a magnetic current of about 300 A and heating time of about 6 s, which demonstrated an HER activity similar to that of commercial Pt/C in both alkaline and acidic media with a respective overpotential (η₁₀) of −12 mV and −23 mV to reach the current density of 10 mA cm⁻².

The Ru nanoparticles supported on carbon substrate are formed by MIHRQ within seconds and include a Cl-enriched surface that is unattainable via conventional thermal annealing. The Ru nanoparticles demonstrate remarkable HER activity in both acidic and alkaline media with an η₁₀ of only −23 mV and −12 mV, respectively. Theoretical studies based on DFT showed that the excellent electrocatalytic activity can be accounted for by the metal-Cl species that facilitate charge transfer and shift of the d-band center. These results highlight the unique advantages of MIHRQ in rapid sample preparation where residual anion ligands play an important role in manipulating the electronic properties of the metal surfaces and hence the electrocatalytic activity.

According to one embodiment of the present disclosure, a method for making a catalyst composition is disclosed. The method includes placing a substrate with at least one precursor composition disposed thereon in contact with a ferromagnetic material and placing the substrate and the ferromagnetic material within an induction solenoid. The method further includes generating an alternating magnetic field within the induction solenoid upon energization by a power source supplying alternating current, thereby heating the substrate and the ferromagnetic material to a temperature of from about 200° C. to about 1,500° C. The method additionally includes rapidly cooling the substrate and the ferromagnetic material.

Implementations of the above embodiment may include one or more of the following features. According to one aspect of the above embodiment, rapidly cooling may further include quenching the substrate and the ferromagnetic material are submerged in a liquid having a temperature of from about −50° C. to about −100° C. The liquid may include an alcohol and dry ice. The precursor composition may include a solution of a nickel salt and iron salt. The nickel salt may be nickel chloride and the iron salt may be iron chloride. The substrate may be a carbon paper. The ferromagnetic material may be an iron sheet. The substrate with the at least one precursor composition may be disposed between two sheets of the ferromagnetic material. The alternating current may be from about 200 amps to about 600 amps. The alternating current may be about 300 amps. The alternating current may be supplied from about 3 seconds to about 12 seconds. The alternating current may be supplied for about 6 seconds. The precursor composition may include a ruthenium halide salt. The ruthenium halide salt may be ruthenium (iii) chloride. Rapidly cooling may form a plurality of nanoparticles, which may include ruthenium and a chloride-rich surface. Rapidly cooling may form a plurality of nanoparticles, which may include the ferromagnetic material and at least one heteroanion.

According to another embodiment of the present disclosure, a catalyst composition is disclosed. The catalyst composition includes a plurality of nanoparticles disposed on a carbon substrate, the plurality of nanoparticles having at least one ferromagnetic material and at least one heteroanion.

Implementations of the above embodiment may include one or more of the following features. According to one aspect of the above embodiment, the plurality of nanoparticles may have an average particle diameter from about 20 nm to about 100 nm. The heteroanion may be chloride. The at least one heteroanion may be present in an amount from about 1% to about 15% by weight of the catalyst composition. The catalyst composition may further include a plurality of nanospindles. The plurality of nanospindles may include a higher amount of chloride than the plurality of nanoparticles. The at least one ferromagnetic material may include iron and nickel. The plurality of nanoparticles may be spinels having oxygen. The spinels may have a formula of Fe₃₋ₓNiₓO₄.

According to a further embodiment of the present disclosure, a catalyst composition is disclosed. The catalyst composition may include a plurality of nanoparticles disposed on a carbon substrate, the plurality of nanoparticles may include ruthenium and one or more heteroanions.

Implementations of the above embodiment may include one or more of the following features. According to one aspect of the above embodiment, the catalyst composition may include the plurality of nanoparticles having an average particle diameter from about 2 nm to about 10 nm. The heteroanion may be chloride. The heteroanion may be present in an amount from about 1% to about 15% by weight of the catalyst composition. The heteroanion may be primarily disposed on a surface of the plurality of nanoparticles. The catalyst composition has an HER overpotential of about −23 mv to reach 10 mA cm⁻² in an acidic medium. The catalyst composition has an HER overpotential of about −12 mV to reach 10 mA cm⁻² in an alkaline medium.

### BRIEF DESCRIPTION OF DRAWINGS

Various embodiments of the present disclosure are described herein below with reference to the figures wherein:

FIG. 1 is a schematic diagram of a magnetic induction heating and rapid quenching (MIHRQ) system according to an embodiment of the present disclosure;

FIGS. 2A-C are photographs of the MIHRQ system with a composite sheet heated by applying current at 200 A, 300 A, and 600 A, respectively, according to an embodiment of the present disclosure;

FIG. 3 shows plots of temperature versus time of magnetic induction heating according to an embodiment of the present disclosure, traditional hydrothermal heating, and pyrolysis heating;

FIG. 4 shows scanning transmission electron microscopy (STEM) images of a FeNiO sample prepared using the MIHRQ system of FIGS. 2A-C heated by applying a current of about 250 amps for a period of about 4 seconds (hereinafter “FeNiO-250-4”) according to an embodiment of the present disclosure;

FIG. 5 shows a high-angle annular dark-filed scanning transmission electron microscopy (HAADF-STEM) image of the morphology of FeNiO-250-4 according to an embodiment of the present disclosure;

FIG. 6 shows an atomic-resolution HAADF-STEM image and an enlarged image (inset in upper right corner) corresponding to the boxed region in FIG. 5 acquired along the <111> zone axis according to an embodiment of the present disclosure;

FIG. 7 shows high-resolution energy-dispersive spectroscopy (EDS)-based elemental maps of Fe and Ni in a FeNiO-250-4 nanoparticle, which features a Fe—Ni spinel structure with no Fe—Ni phase segregation according to an embodiment of the present disclosure;

FIG. 8 is a high-resolution TEM (HRTEM) image of nanospindles in FeNiO-250-4;

FIGS. 9A-B are HAADF-STEM images of nanospindles at an edge of FeNiO-250-4 (low-contrast regions), as highlighted by arrows;

FIG. 10 shows EDS mapping images of the interface between nanospindles and nanoparticles in FeNiO-250-4, illustrating a Cl-rich surface of the nanospindles according to an embodiment of the present disclosure;

FIG. 11 shows HAADF-STEM images of FeNiO sample prepared using the MIHRQ system of FIGS. 2A-C using natural cooling (hereinafter “FeNiO_{NC}-250-4”) according to an embodiment of the present disclosure;

FIG. 12 shows EDS mapping images of FeNiO_{NC}-250-4 according to an embodiment of the present disclosure;

FIG. 13 shows HAADF-STEM images of FeNiO sample prepared using the MIHRQ system of FIGS. 2A-C using prolonged heating of about 16 seconds (hereinafter “FeNiO-250-16”)

FIG. 14 shows EDS mapping image of FeNiO-250-16 according to an embodiment of the present disclosure;

FIG. 15 is an X-ray photoelectron spectroscopy (XPS) scan of the Ni 2p electrons of FeNiO-250-4 according to an embodiment of the present disclosure;

FIG. 16 is an XPS scan of the Fe 2p electrons of FeNiO-250-4 according to an embodiment of the present disclosure;

FIG. 17 is an XPS scan of the O 1s electrons of FeNiO-250-4 according to an embodiment of the present disclosure;

FIG. 18 is the Ni K-edge X-ray absorption near edge structure (XANES) spectra of FeNiO-250-4, FeNiO_{NC}-250-4, and FeNiO-250-16 and reference samples of Ni and NiO, according to an embodiment of the present disclosure;

FIG. 19 is the Fe K-edge XANES spectra of FeNiO-250-4, FeNiO_{NC}-250-4, and FeNiO-250-16 and reference samples of Fe and Fe₂O₃, according to an embodiment of the present disclosure;

FIG. 20 is the Fourier transformed extended X-ray absorption fine structure spectra (FT-EXAFS) of Ni of FeNiO-250-4, FeNiO_{NC}-250-4, and FeNiO-250-16 and reference samples of Ni and NiO, according to an embodiment of the present disclosure;

FIG. 21 is the Fourier transformed extended X-ray absorption fine structure spectra (FT-EXAFS) of Fe of FeNiO-250-4, FeNiO_{NC}-250-4, and FeNiO-250-16 and reference samples of Fe and Fe₂O₃, according to an embodiment of the present disclosure;

FIG. 22 shows linear sweep voltammetry (LSV) curves of FeNiO-250-4, FeNiO-250-4-NC, FeNiO-250-16 and 20% ruthenium/carbon (Ru/C) in 1 M potassium hydroxide (KOH) according to an embodiment of the present disclosure;

FIG. 23 shows Tafel plots of FeNiO-250-4, FeNiO-250-4-NC, FeNiO-250-16 and 20% ruthenium/carbon (Ru/C) in 1 M potassium hydroxide (KOH) according to an embodiment of the present disclosure;

FIG. 24 shows polarization plots of FeNiO-250-4 in the first scan, after 10 hours stability tests at 1.53 V and after additional 1000 CV cycles within the potential range of 1.20 to 1.65 V at the scan rate of 10 mV s⁻¹ with a corresponding i-t curve shown in the figure inset according to an embodiment of the present disclosure;

FIG. 25 shows a free energy profile of OER on Ni(OH)Fe₂O₄(Cl), Ni(OH)Fe₂O₄, Fe(OH)Fe₂O₄(Cl), Fe(OH)Fe₂O₄, Ni(OH)NiO(Cl), and Ni(OH)NiO according to an embodiment of the present disclosure;

FIG. 26 shows a chemical structural model of Ni(OH)Fe₂O₄(Cl);

FIG. 27 shows a chemical structural model of Ni(OH)Fe₂O₄;

FIG. 28 shows a chemical structural model of Fe(OH)Fe₂O₄(Cl);

FIG. 29 shows a chemical structural model of Fe(OH)Fe₂O₄;

FIG. 30 shows a chemical structural model of Ni(OH)NiO(Cl);

FIG. 31 shows a chemical structural model of Ni(OH)NiO;

FIG. 32 is a charge density difference isosurface with a value of 0.01 of Fe(OH)Fe₂O₄;

FIG. 33 is a charge density difference isosurface with a value of 0.01 of Fe(OH)Fe₂O₄(Cl);

FIG. 34 is a charge density difference isosurface with a value of 0.01 of Ni(OH)Fe₂O₄;

FIG. 35 is a charge density difference isosurface with a value of 0.01 of Ni(OH)Fe₂O₄(Cl);

FIG. 36 is a diagram of evolution of bond distances of HO*—#O species of Fe(OH)Fe₂O₄;

FIG. 37 is a diagram of evolution of bond distances of HO*—#O species of Fe(OH)Fe₂O₄(Cl);

FIG. 38 is a diagram of evolution of bond distances of HO*—#O species of Ni(OH)Fe₂O₄;

FIG. 39 is a diagram of evolution of bond distances of HO*—#O species of Ni(OH)Fe₂O₄(Cl);

FIG. 40 is a schematic illustration of a method of preparing Ru nanoparticles supported on carbon paper using the MIHRQ system according to an embodiment of the present disclosure;

FIG. 41 is a transmission electron microscopy (TEM) image of Ru nanoparticles at low magnification;

FIG. 42 is a core size histogram for Ru nanoparticles;

FIG. 43 is a high-resolution TEM (HRTEM) image of an Ru nanoparticle with the corresponding fast-Fourier transform (FFT) image shown in the inset;

FIGS. 44A-C are TEM images of Ru nanoparticles prepared by applying a current of about 200 amps for a period of about 6 seconds (Ru-200), in which circled areas highlight the Ru nanoparticles which feature an interplanar spacing of about 0.23, consistent with hexagonal Ru;

FIGS. 45A-B are high-resolution TEM images of Ru nanoparticles prepared by applying a current of about 300 amps for a period of about 6 seconds (Ru-300) with insets showing are the FFTs of the boxed areas;

FIG. 46A-C are TEM images of Ru nanoparticles prepared by applying a current of about 600 amps for a period of about 6 seconds (Ru-600);

FIG. 47A-C are TEM images of Ru nanoparticles prepared by applying a current of about 300 amps for a period of about 3 seconds (Ru-300-S);

FIG. 48A-C are TEM images of Ru nanoparticles prepared by applying a current of about 300 amps for a period of about 12 seconds (Ru-600-L);

FIG. 49 shows an annular dark-filed (ADF) TEM image of Ru nanoparticles and corresponding elemental maps of Ru, chlorine (Cl), and oxygen (O) of the circled area;

FIG. 50 shows X-ray photoelectron spectroscopy (XPS) survey spectra of Ru-200, Ru-300, Ru-400, Ru-600, Ru-300-S, and Ru-300-L;

FIG. 51 shows Ru 3p XPS spectra of Ru-200, Ru-300, Ru-400, and Ru-600;

FIG. 52 shows Ru 3p XPS spectra of Ru-300-S, Ru-300, and Ru-300-L;

FIGS. 53A-B show C 1s and Ru 3d XPS spectra of Ru-200, Ru-300, Ru-400, Ru-600, Ru-300-S, Ru-300, and Ru-300-L;

FIG. 54 shows Cl 2p XPS spectra of Ru-200, Ru-300, Ru-400, and Ru-600

FIG. 55 shows Cl 2p e XPS spectra of Ru-300-S, Ru-300, and Ru-300-L;

FIG. 56A-B shows O 1s XPS spectra of Ru-200, Ru-300, Ru-400, Ru-600, Ru-300-S, Ru-300, and Ru-300-L;

FIG. 57 shows Raman spectra of RuCl₃, Ru-200, Ru-300, Ru-400, and Ru-600;

FIG. 58 shows X-ray absorption near edge spectra (XANES) for Ru-200, Ru-300, Ru-400, Ru-600, Ru, and RuO₂;

FIG. 59 shows Fourier transformed extended X-ray absorption spectra (FT-EXAFS) of Ru-200, Ru-300, Ru-400, Ru-600, Ru, and RuO₂;

FIGS. 60A-F show EXAFS fittings of Ru-200, Ru-300, Ru-400, Ru-600, Ru-300-S, and Ru-300-L;

FIGS. 61A-B show X-ray absorption near edge spectra (XANES) and corresponding Fourier transformed extended X-ray absorption spectra (FT-EXAFS) of Ru-300-S, Ru-300, Ru-300-L;

FIGS. 62A-B show linear scanning voltammetry (LSV) curves and corresponding Tafel plots of Ru-200A, Ru-300, Ru-400, Ru-600, and RuCl₃ with scan rate of 10 mV s⁻¹ in 0.5 M H₂SO₄;

FIGS. 63A-B show LSV curves and corresponding Tafel plots of Ru-300-S, Ru-300, and Ru-300-L with scan rate of 10 mV s⁻¹ in 0.5 M H₂SO₄;

FIGS. 64A-B show LSV curves and corresponding Tafel plots of Ru-200, Ru-300, Ru-400, Ru-600, and RuCl₃ with scan rate of 10 mV s⁻¹ in 1 M KOH;

FIGS. 65A-B show LSV curves and corresponding Tafel plots of Ru-300-S, Ru-300, and Ru-300-L in 1 M KOH with scan rate of 10 mV s⁻¹ in 1 M KOH;

FIGS. 66A-B show LSV curves for a stability test of Ru-300 in 0.5 M H₂SO₄ and 1 M KOH;

FIGS. 67A-B show Ru 2p and Cl 2p XPS spectra after stability test in acidic (H₂SO₄) and alkaline (KOH) media;

FIG. 68 shows computational models of 10-11 facet of hcp Ru (Ru-101) with various RuClₓ species (tCl, hCl, 2hCl, RuCl₂, RuCl);

FIG. 69 shows an initial input model of on-top H adsorption on Ru-101;

FIG. 70 shows plots of Gibbs free energy of H* (ΔG_{H*}) adsorption on corresponding models of FIG. 68;

FIG. 71 shows a computational model of Ru-101-2hCl with an H atom adsorbed on the adjacent hollow site after relaxing;

FIG. 72 shows plots of projected density of states (PDOS) of d-electrons of Ru active sites models of FIG. 68;

FIGS. 73A-D show computational models of Ru-101-RuCl₂ (a, b) and Ru-101-RuCl (c, d) with adsorbed H atom after relaxing;

FIG. 74 shows plots of calculated total DOS of Ru-101, Ru-101-hCl, Ru-101-RuCl₂, Ru-101-RuCl;

FIGS. 75A-B show a computational model for Ru-101-2hCl and corresponding plots of PDOS of d-electrons for different Ru atoms;

FIGS. 76A-C show computational models for Bader charge analysis: (a) Ru-101-RuCl₂, (b) Ru-101-RuCl, and (c) Ru-101-tCl;

FIGS. 77A-C show Bader charge analysis of (a) Cl—, (b) RuCl2+, and (c) RuCl2+ on the surface of Ru (10-11) illustrating electron loss and electron gain with an isovalue of charge density of 0.001 e au⁻³; and

FIG. 78 shows a relaxed model of RuCl₃ on Ru (10-11).

### DETAILED DESCRIPTION

The present disclosure is directed to a catalyst composition including a nanocomposite material having a carbon substrate and a plurality of nanoparticles, which may be Fe—Ni spinel nanoparticles or Ru nanoparticles, disposed on the carbon substrate. As used herein, the term “nanoparticle” denotes a particle having any shape and size from about 1 nm to about 100 nm. As used herein the terms “about”, “approximately”, and other relative terms, denote a range of +5% of the stated value.

The nanoparticles according to the present disclosure may be formed from a precursor composition disposed on a substrate placed between ferromagnetic material sheets, which allow for rapid induction heating. The heating process is followed by rapid cooling via quenching to form nanoparticles that are doped with heteroanions provided by the precursor composition.

Induction heating is a process of heating an electrically conductive material via magnetic induction, through heat generated in the material by Eddy currents. An induction heater may include an electromagnet and an electronic oscillator that passes a high-frequency alternating current (AC) through the electromagnet. The rapidly alternating magnetic field passes through the material, generating Eddy currents therein. The Eddy currents encounter the resistance of the material thereby heating it by Joule heating. In ferromagnetic materials, such as Ni and Fe, heat may also be generated by magnetic hysteresis losses.

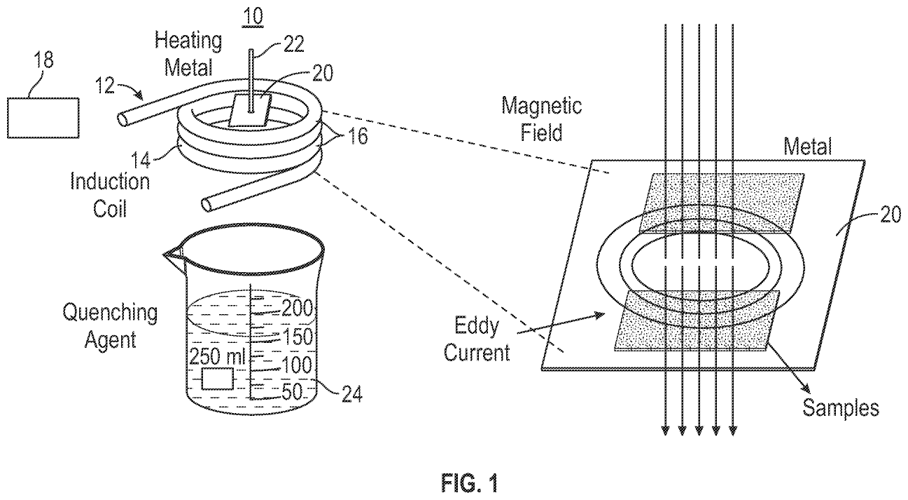

With reference to FIG. 1, a system 10 for making the catalyst composition according to the present disclosure includes an electromagnet 12, which may be an induction coil 14 having a plurality of loops or windings 16. The windings 16 may be substantially circular and may have any suitable diameter, which may be from about 4 cm to about 10 cm. The induction coil 14 is coupled to a power source 18 configured to supply high frequency alternating current having a frequency from about 20 kHz to about 100 kHz.

The catalyst composition may be formed by contacting a precursor composition with a ferromagnetic material. In embodiments, the precursor composition may be a solution of salts including Ni and Fe salts, such as NiCl₂ and FeCl₃. Suitable solvents include any polar solvent, such as water. The precursor composition may also include urea.

The catalyst composition may also be formed by placing a precursor composition on a substrate. In embodiments, the precursor composition may include a catalytic metal halide salt, such as metal chlorides, metal fluorides, metal iodides, and the like. Catalytic metals of the halide salt may include platinum (Pt), palladium (Pd), rhodium (Rh), iridium (Ir), ruthenium (Ru), nickel (Ni), osmium (Os), manganese (Mn), iron (Fe). Suitable catalytic metal halide salts may include, but are not limited to, platinum (II) chloride (PtCl₂), rhodium (III) chloride (RhCl₃), iridium (III) chloride (IrCl₃), ruthenium (III) chloride (RuCl₃), and the like

The precursor composition may be a solution of the catalytic metal halide salt dissolved in any suitable solvent, which include, but is not limited to, acetone, alcohols, water, and other polar solvents.

The precursor composition may be placed on a substrate, such as carbon paper, using any liquid deposition technique, including drop casting, solution casting, and the like. The loaded substrate is then placed in contact with a ferromagnetic material, such as an Fe, Ni, and combinations thereof. The ferromagnetic material may be in the shape of a sheet. In embodiments, the ferromagnetic material may have a larger surface area than the substrate, such that the substrate is completely covered by the iron sheet. In further embodiments, the substrate may be placed between a pair of ferromagnetic sheets to form a composite sheet 20.

The composite sheet 20 may be suspended inside the induction coil 14 using a metal post 22, such as an iron nail, which is then attached to a holder or any other apparatus for securing the composite sheet 20 relative to the induction coil 14 without physical contact therebetween. The composite sheet 20 may be heated to a temperature of from about 200° C. to about 1,500° C. Various combinations of the induction coil 14, i.e., materials, thickness, shape, configuration, and operating parameters of the power source 18 may be adjusted to heat the sample to a desired temperature.

The composite sheet 20 may be disposed within the induction coil 14 using any suitable support structure. In embodiments, the composite sheet 20 may be suspended by one or more shafts 22. In further embodiments, the composite sheet 20 may be supported by a scaffold or a post (not shown). The shaft 22 may be operated by a submerging mechanism (e.g., clamp) configured to lower the composite sheet 20 into the cooling bath 24.

The system 10 also includes a cooling bath 24 disposed underneath the induction coil 14 to allow for the composite sheet 20 to be submerged (e.g., dropped) in the cooling bath 24 thereby quenching the composite sheet 20. The cooling bath 24 may be from about −50° C. to about −100° C. The cooling bath 24 may be any liquid mixture or composition configured to rapidly cool the heated composite sheet 20. In embodiments, the liquid mixture or composition may include a solvent, e.g., ethanol, and a cooling agent, e.g., dry ice (solid carbon dioxide).

Quenching is performed after the composite sheet 20 has been sufficiently heated to reach the desired temperature. Sufficient heating may be determined once a suitable parameter (e.g., time, temperature, current, etc.) reaches a threshold. The parameter may be measured using a corresponding sensor, such as a timer, a temperature sensor configured to measure the temperature of the composite sheet 20 during heating, a current sensor to monitor current output by the power source 18, etc. The sensor may be used in a control loop operating the submerging mechanism configured to quench the composite sheet 20 once the parameter reaches the threshold.

The rapid heating and quenching process includes increasing and lowering the temperature of the composite sheet 20 at a rate of from about 500 K s⁻¹ to about 1,000 K s⁻¹. This process as shown in FIG. 40 forms the catalyst composition having a plurality of catalyst nanoparticles formed from the catalyst metal, e.g., Ru. The nanoparticles are disposed on the carbon substrate and may have an average particle diameter from about 1 nm to 20 nm, and in embodiments from about 2 nm to about 10 nm. The catalyst composition also includes one or more heteroanion, e.g., Cl, disposed on the surface of the nanoparticles.

The rapid heating and quenching produce a nanoparticle surface that is rich with heteroanions, e.g., Cl, provided by the precursor salt with the core of the nanoparticle being primarily formed from the catalyst metal, e.g., Ru. A Cl-rich surface contributes to the relatively high catalytic HER activity of the nanoparticles of the catalyst composition in both acidic and alkaline media with an overpotential of only −23 mV and −12 mV, respectively, to reach the current density of 10 mA cm⁻².

The amount of hetereanion present on the surface of the catalyst metal nanoparticles depends on the amount and duration of heat applied to the composite sheet 20. The heteroanion may be present in an amount from about 1% to about 15% by weight of the catalyst composition. The heteroanion is present primarily on the surface of the nanoparticles, which may be from about 80% to about 100% of the total amount of the heteroanion. In embodiments, the power source 18 may be energized to supply a current from about 100 amps to about 600 amps, and in embodiments from about 200 amps to about 400 amps, and in further embodiments about 300 amps. The current may be applied from about 1 second to about 20 seconds, and in embodiments from about 3 seconds to about 12 seconds, and in further embodiments about 6 seconds.

In embodiments, where Fe and Ni compounds are used as precursor materials, the catalyst composition includes a plurality of FeNi oxide spinel nanoparticles having a formula of Fe₃₋ₓNiₓO₄. The nanoparticles are disposed on the carbon substrate and may have an average particle diameter from about 20 nm to 100 nm. The catalyst composition also includes a plurality of nanospindles or nanocrystals having an average particle diameter from about 1 nm to about 5 nm. The catalyst composition also includes one or more heteroanion, e.g., Cl, disposed on the surface of the nanoparticles and within and/or on the surface of the nanospindles. The catalyst composition may include Fe from about 20% to about 40% by weight of the composition, oxygen (O) from about 50% to about 60% by weight of the composition, Ni from about 5% to about 15% by weight of the composition, and Cl from about 1% to about 15% by weight of the composition. In embodiments, Fe, Ni, O, and Cl may be present at a ratio from about 1.9:1:4.9:1.1 to about 4.1:1:5.8:0.2.

The rapid temperature changes during heating and cooling impede phase segregation of Ni and Fe resulting in atomic mixing of Ni and Fe. The rapid heating and quenching also produces a surface rich with heteroanions, e.g., Cl, provided by the precursor salt. Lack of phase segregation and Cl-rich surface contribute to the relatively high catalytic activity needing only 260 mV to reach the high current density of 100 mA cm⁻² as described in the Examples section below.

The catalyst compositions according to the present disclosure may be used in hydrogen evolution reaction (HER), a water splitting electrolysis reaction. The rate of hydrogen generation from the HER according to present disclosure may be affected by the pH and temperature at which HER is carried out. Accordingly, the HER may be carried out at a pH from about 0 (0.5M H2SO4 to 14 (1 M KOH), from about 9 to about 13, and in embodiments from about 10 to about 12. The HER may also be carried at a temperature from about 22° C. and 100° C., in embodiments from about 30° C. to about 80° C., and in further embodiments, from about 40° C. to about 60° C. HER may be carried with any suitable water; however, certain impurities present in the water may affect the rate of hydrogen generation.

The method for hydrogen generation according to the present disclosure includes providing a catalyst composition according to the present disclosure and exposing the catalyst composition to a hydrogen containing compound such as water or an aqueous solution. Exposure to the compound may be carried by placing the catalyst composition in a liquid container.

The hydrogen containing compound may be an aqueous alkaline medium, which may be prepared by dissolving an alkaline compound including alkali metal hydroxides such as lithium hydroxide, sodium hydroxide and potassium hydroxide, and tetraalkylammonium hydroxides such as tetramethylammonium hydroxide and tetraethylammonium hydroxide. Suitable solvents include pure water or water that is mixed with various water-miscible solvents including alcohols such as methyl and ethyl alcohols, dimethylformamide, dimethylacetamide, ethyleneglycol, diethyleneglycol and the like. The aqueous alkaline medium may include from about 1% by to about 30% by weight of the alkaline compound dissolved therein. The generated hydrogen may be collected or syphoned for later use. In further embodiments, the generated hydrogen may be used directly with any system and or apparatus that utilizes hydrogen as a source of fuel, such as a fuel cell.

The following Examples illustrate embodiments of the present disclosure. These Examples are intended to be illustrative only and are not intended to limit the scope of the present disclosure. Also, parts and percentages are by weight unless otherwise indicated. As used herein, “room temperature” or “ambient temperature” refers to a temperature from about 20° C. to about 25° C.

### EXAMPLES

### Example 1

This example describes synthesis of FeNi spinel.

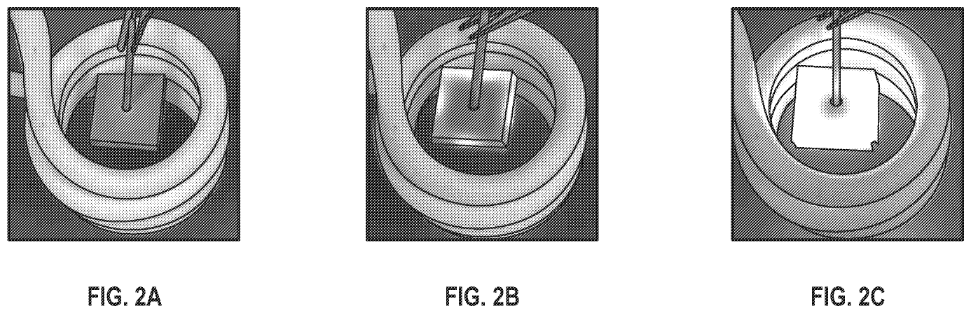

An MIHRQ apparatus as shown in FIGS. 2A-C was used to form FeNi spinels. A four-turn induction solenoid was twisted at a diameter of about 5 cm. A beaker containing ethanol and dry ice as the quenching agent at a temperature of about −78° C. was placed under the solenoid.

Carbon paper (source: Toray Industries, Inc.) was cut into 1 cm×1.5 cm pieces. A solution was prepared by dissolving 40 mg of NiCl₂·6H₂O, 10 mg of FeCl₃ and 0.8 g of urea into 10 ml of water (supplied with a Barnstead Nanopure Water System, 18.2 MΩ cm). 100 μL of the solution was dropcast onto the carbon paper, which was then dried at ambient temperature and sandwiched between two iron sheets of 2.5 cm×2.5 cm×0.1 cm.

An iron nail was inserted into the center of the iron sheets and clamped to hold the assembly, which was placed in the center of the induction solenoid. A high frequency current at about 30 kHz was passed through the solenoid, producing a strong magnetic field, which instantly generated a strong Eddy current in the iron sheets, and thus, heating the sample rapidly to a high temperature.

The induction current and time was varied to control the heating temperature. A solenoid current of 200 A for a heating time of 4 s generated a temperature of about 200-300° C., which barely changed the color of the iron sheets (FIG. 2A). When the solenoid current was increased to 400 A and 600 A, the temperature reached about 600° C. and 1,500° C., respectively, inducing a glowing color of the iron sheets from faint red to white (FIGS. 2B and 2C).

After a period of heating (e.g., less than one minute), the sample was dropped into the quenching solution of an ethanol-dry ice at about −78° C., which was placed underneath the induction coil for rapid quenching. Control samples were removed from the solenoid and cooled down naturally under ambient conditions. This offered an additional control of the materials structures.

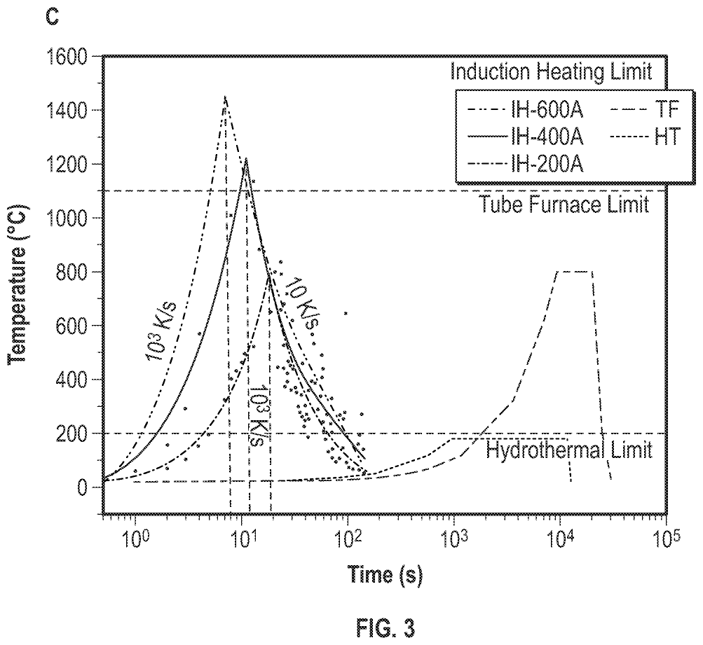

FIG. 3 shows plots of variations of temperature versus time of magnetic induction heating, traditional hydrothermal heating, and pyrolysis. “IH”, “TF”, and “HT” denotes induction heating, tube furnace, and hydrothermal heating, respectively. The vertical dashed lines indicate the cases with the quenching process and current values for IH plots.

A series of samples were prepared with the MIHRQ setup at a controlled induction current (X=100-600 A) for a select period of time (Y=2-16 s), and referred to hereinafter as FeNiO-X-Y, FeNiO-250-4 and FeNiO-250-16. Control samples were prepared in the same manner except for cooling under ambient conditions, and referred to hereinafter as FeNiO_{NC}-X-Y, e.g., FeNiO_{NC}-250-4.

### Example 2

This Example describes structural characterization of samples of Example 1.

Structural characterization was carried out using STEM experiments, which were conducted with a transmission electron microscope equipped with an X-FEG field-emission source, operated at 200 keV. HAADF-STEM imaging and EDS analysis was also performed on the samples, which were first sonicated, dispersed in ethanol, and then deposited onto copper grids for TEM characterization. SEM studies were carried out on FEI Quanta 3D FEG dual beam instrument. XPS measurements were performed with a Phi 5400/XPS instrument equipped with an Al K_{α} source operated at 350 W and 10-9 Torr. XRD patterns were acquired with a Bruker D8 Advance diffractometer with Cu K_{α radiation (}λ=0.15418 nm).

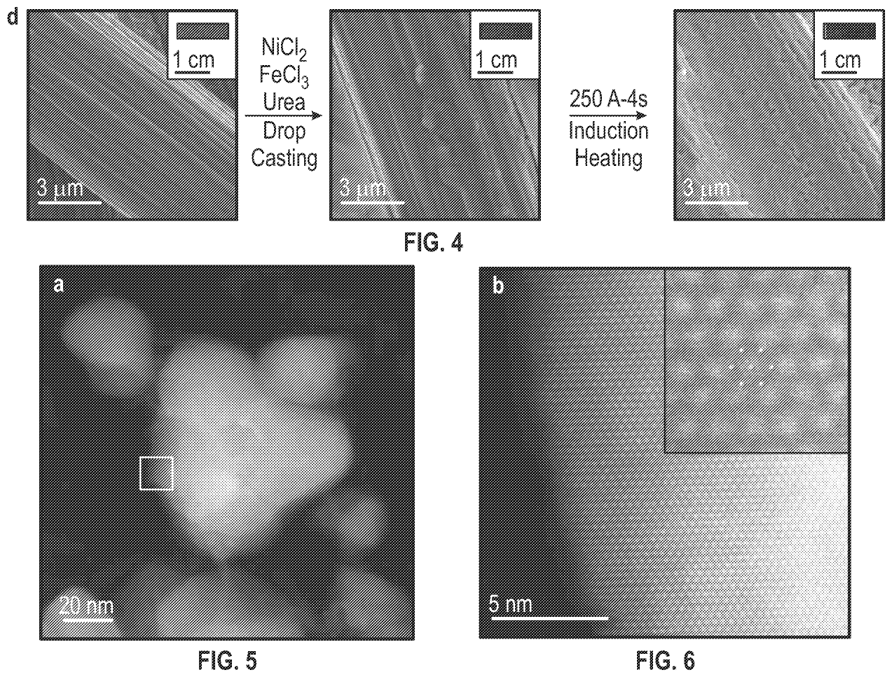

STEM measurements of the NiFeO-250-4 sample and of the NiFeO-250-4 sample were obtained at different preparation stages are shown in FIG. 4. The inset images in upper right corners of each stage are photographs of corresponding electrodes. The carbon paper became darkened after the deposition of the metal salt precursors, and subsequent induction heating and rapid quenching lead to a pitch-black appearance of the carbon paper, with particulates formed onto the carbon fibers.

HAADF-STEM images were also obtained and show formation of a number of nanoparticles having an average particle diameter from about 20 nm to 100 nm in irregular shapes as shown in FIG. 5. The structure is consistent with Fe₃₋ₓNiₓO₄-type spinel, as observed along the <111> zone axis as shown in FIG. 6. The interatomic distance was estimated to be 0.816-0.824 nm (inset of FIG. 6), close to that of FeNi spinel oxide (0.835 nm) and confirmed the spinel lattice structure.

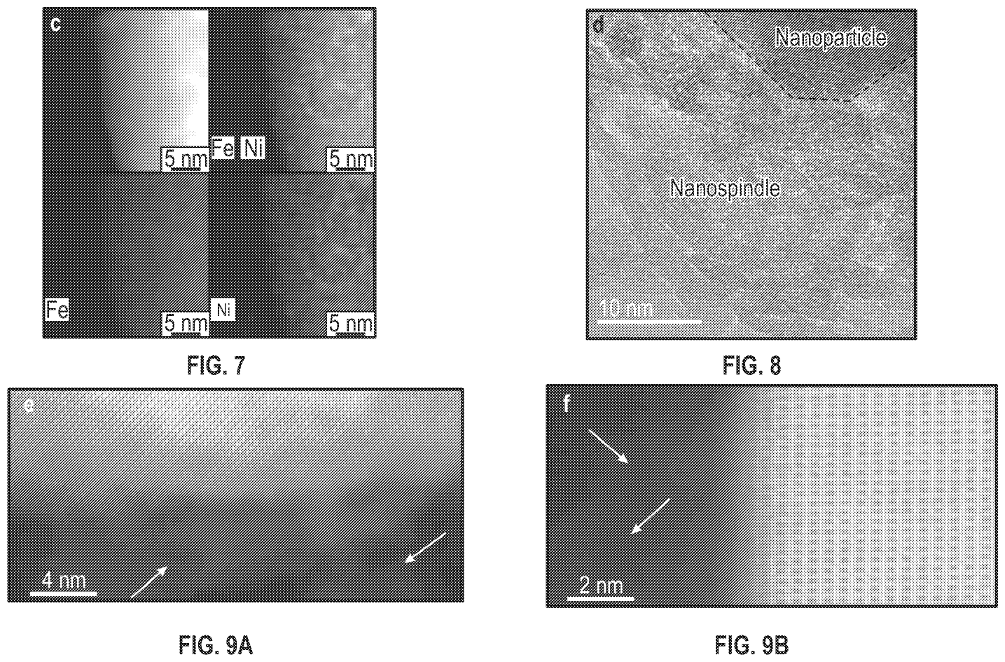

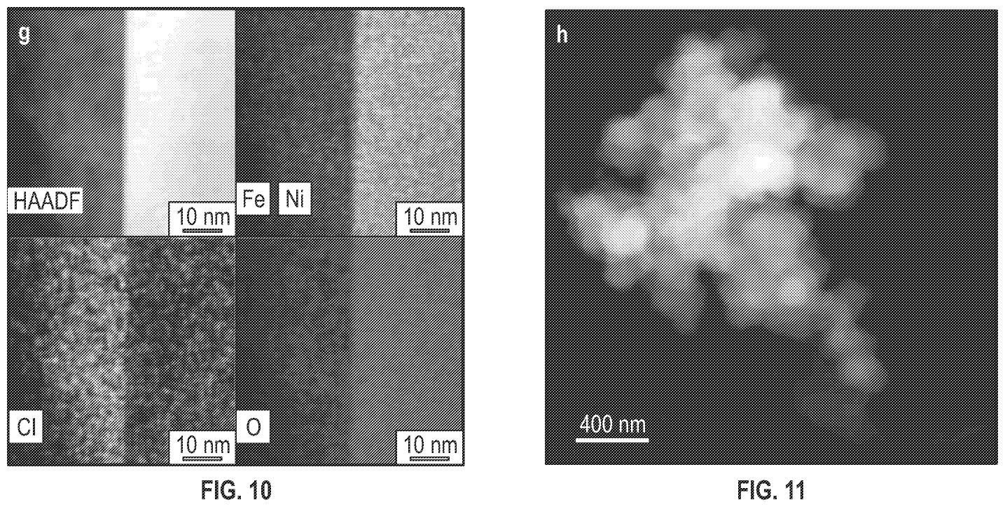

Furthermore, energy-dispersive X-ray spectroscopy (EDS)-based elemental mapping studies also demonstrated an even distribution of Fe and Ni within the lattice, as shown in FIG. 7, suggesting atomic mixing of the Fe and Ni elements and no phase segregation. Notably, spindle-like FeNi oxide nanocrystals (i.e., nanospindles) were also found around these nanoparticles as shown in FIG. 8. With reference to FIGS. 9A-B, nanospindles are highlighted by arrows and were located at an edge of FeNiO-250-4 (low-contrast regions). These images show that the nanospindles had a chlorine-rich surface (FIG. 10), with a Cl concentration of 12 at % (atomic percent) in comparison to under 2 at % within the nanoparticles as shown in Table 1 below, which lists elemental contents of the samples based on EDS measurements.

TABLE 1

| | at % | | | |
|---|---|---|---|---|
| | | FeNiO-250-4 | | |
| element | FeNiO-250-4 | (spindle) | FeNiO_{NC}-250-4 | FeNiO-250-16 |
| Fe | 37.01 | 20.99 | 4.4 | 40.6 |
| O | 51.77 | 54.89 | 61.18 | 52.39 |
| Ni | 8.95 | 11.13 | 26.22 | 6.11 |
| Cl | 1.96 | 12.01 | 0.95 | 0.17 |

The atomic ratio of Fe:Ni:O:Cl in the nanospindles was estimated to be 1.9:1:4.9:1.1, while the overall ratio was close to 4.1:1:5.8:0.22, indicating that the spinel nanoparticles were Fe-rich oxide, while the nanospindles represented an intermediate phase between the precursors (metal chlorides) and the final spinel crystal. Furthermore, the Fe:Ni ratio was higher than the feeding ratio, which was likely due to Ni not being fully converted into Ni oxide and being washed away during the rapid quenching process.

For FeNiO-250-16, which was prepared via a longer heating time, the Fe:Ni:O:Cl ratio was estimated to be 6.6:1:8.6:0.028 (Table 1), indicative of the formation of a Fe-rich structure that was almost free of Cl. The nanospindle features, with the unique chlorine rich surface, were produced with a short heating time and rapid quenching process.

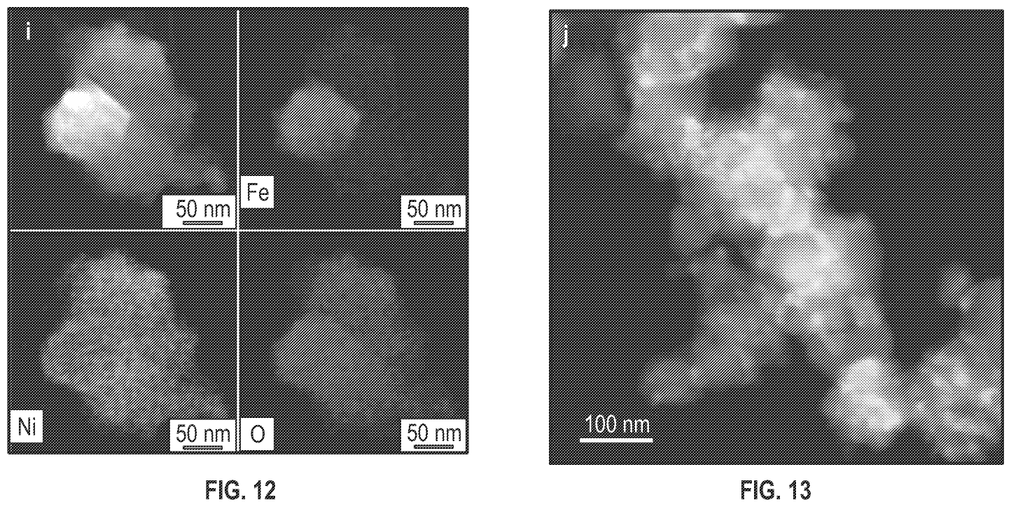

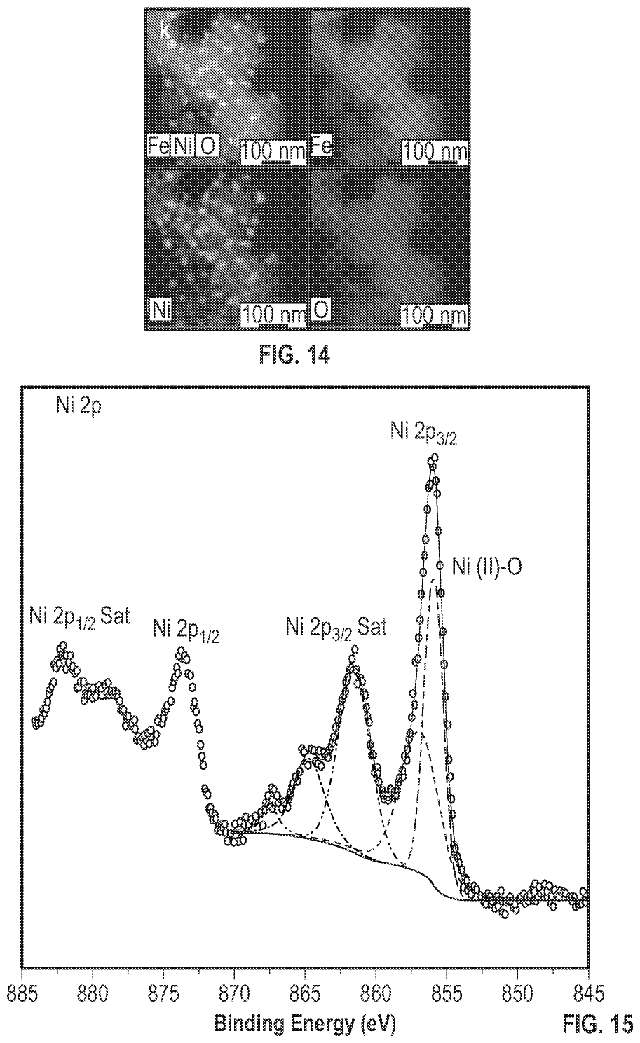

The control sample, FeNiO_{NC}-250-4 that was produced by similar heating but natural cooling in the ambient, exhibited a different morphology as shown in FIG. 11. In particular, FeNiO_{NC}-250-4 included aggregates of nanoparticles clumped large chunks. In addition, significant phase segregation occurred within the sample as shown in FIG. 12, where the elements of Ni and O appeared to be evenly distributed across the sample, whereas Fe was mostly confined within a small region, suggesting the growth of FeNiO spinel nanocrystals on a nickel oxide scaffold. This is consistent with the sample atomic ratio of Fe:Ni:O:Cl=0.15:1:2.3:0.036. The fact that the sample was markedly nickel-rich was likely due to higher thermal volatility of the iron compounds, where the enhanced loss of Fe was facilitated by the relatively slow cooling (about 10 K s⁻¹). With reference to FIGS. 13 and 14, similar phase segregation was also observed with a prolonged heating time (e.g., FeNiO-250-16), where the temperature could reach approximately 1,500° C. Prolonged heating resulting in higher temperature leads to the formation of a significant amount of metallic Ni nanoparticles on the Fe—Ni spinel.

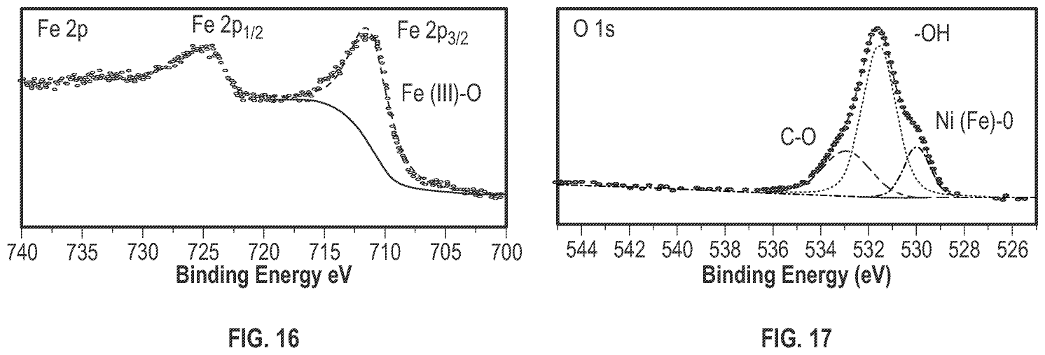

The material were further characterized by X-ray photoelectron spectroscopy (XPS) and X-ray absorption spectroscopy (XAS) measurements. FIG. 15 shows the high-resolution XPS scan of the Ni 2p electrons of FeNiO-250-4, where two peaks were resolved at 855.9 and 856.9 eV for the Ni(II) 3p_{3/2} electrons, suggesting the formation of five and six oxygen-coordinated Ni atoms on the surface (i.e., Ni(OH)₂), respectively, since no NiO species, having binding energy around 854.7 eV, were detected. A single peak was resolved at 711.2 eV in the Fe 2p scan (FIG. 16), due to the Fe(III) 3p_{3/2} electrons, whereas three peaks were deconvoluted in the O 1s spectrum (FIG. 17) at 531.5 eV for hydroxide, 529.9 eV for metal-O, and 533.0 eV for C—O. These observations are consistent with the formation of FeNiO spinel lattices (vide infra). These results suggest that the FeNiO-250-4 sample surface was mostly terminated with OH and Cl groups, in good agreement with results from the TEM and EDS measurements.

Further oxidation states and structural insights were obtained by XAS measurements. Fe and Ni K-edge XAS data was collected from the CLS@APS Sector 20-BM beamline at the Advanced Photon Source (operating at 7.0 GeV) in Argonne National Labs, Chicago, IL, USA. Samples were enclosed within Kapton tape and measured in fluorescence mode simultaneously with each elements foil reference. All measurements were conducted at room temperature and ambient pressure. EXAFS data was transformed and normalized into k- and R-space using the Athena program following conventional procedures. A k weighting of 2 was used to obtain all FT-EXAFS spectra. The k-range used for each sample is as follows for Fe: 3.1-9.2 Å⁻¹ for FeNiO-250-4, 2.1-9.1 Å⁻¹ for FeNiO_{NC}-250-4, 3.3-12.7 Å⁻¹ for FeNiO-250-16. For Ni the k-range used was as follows: 3.0-8.9 Å⁻¹ for FeNiO-250-4, 2.9-12.2 Å⁻¹ for FeNiO_{NC}-250-4, 2.6-14.4 Å⁻¹ for FeNiO-250-16. The R-range used for Fe is as follows: 1.0-3.7 Å for FeNiO-250-4, 1.0-3.6 Å for FeNiO_{NC}-250-4, 1.0-3.4 Å for FeNiO-250-16. The R-range used for Ni is as follows: 1.0-3.5 Å for FeNiO-250-4, 1.0-3.0 Å for FeNiO_{NC}-250-4, 1.0-3.0 Å for FeNiO-250-16. Self-consistent multiple-scattering calculations were performed using the FEFF6 program to obtain the scattering amplitudes and phase-shift functions used to fit various scattering paths with the Artemis program. In the fitting of each sample the E₀ values were correlated together to minimize the number of independent values, allowing reliable fitting results to be obtained. The σ² values were also correlated for some samples.

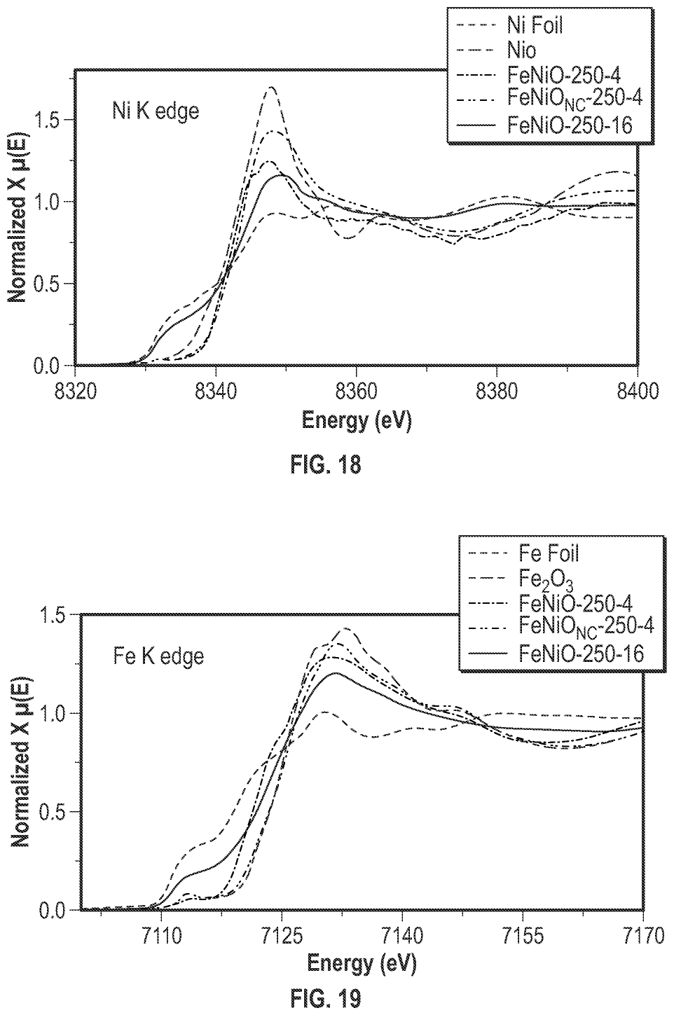

FIG. 18 depicts the Ni K edge XANES spectra of the sample series where the absorption edge intensity varies in the order of Ni foil <FeNiO-250-16<FeNiO-250-4<FeNiO_{NC}-250-4<NiO, suggesting that the Ni valence state in the three FeNiO samples was in the intermediate between those of metallic Ni and Ni²⁺. A similar trend was observed in the Fe K edge XANES in FIG. 19, where all samples show a clear deviation from that of Fe foil, with the absorption edge intensity varying in the order of Fe foil <FeNiO-250-16<FeNiO-250-4<FeNiO_{NC}-250-4<Fe₂O₃, confirming that the Fe valence state in the three FeNiO samples was in the intermediate between those of metallic Fe and Fe³⁺. Importantly, the Ni and Fe elements of FeNiO-250-4 can be seen to possess an average oxidation state between those of FeNiO_{NC}-250-4 and FeNiO-250-16, likely due to reduced carbothermal effects by the rapid heating and quenching process.

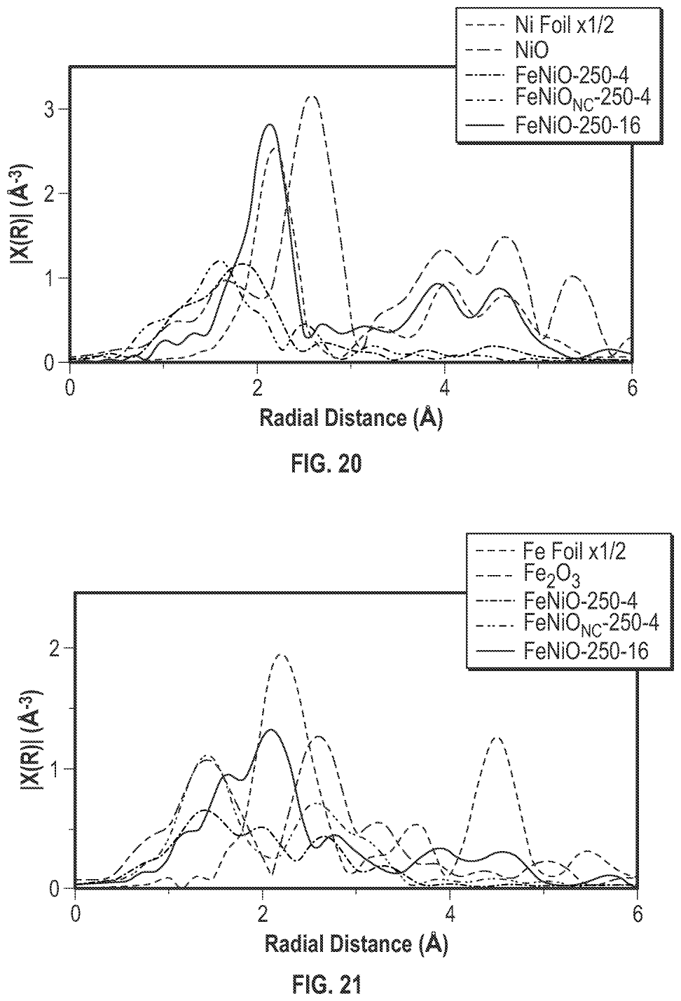

Further insights into the bonding configurations of the metal centers were obtained from the EXAFS results. Fitting of the FT-EXAFS data of FIG. 20 showed that FeNiO-250-4 possessed Ni—O bonds with a bond length of 2.3 Å, somewhat smaller than those of FeNiO_{NC}-250-4 (2.5 Å) and rock salt NiO (2.9 Å). This is consistent with the phase segregation in FeNiO_{NC}-250-4 (vide ante). Meanwhile, the Ni—Cl path in FeNiO-250-4 was found to possess a coordination number (CN) of 3 and an average bond length of 2.40 Å, slightly larger than Ni—O (CN=2.7). Due to the low cooling rate, severe Cl loss occurred with FeNiO_{NC}-250-4 leading to a low CN of 1.5, while its Ni—O showed a CN of 4.7, consistent with the absence of nanospindles in TEM measurements (FIG. 4). The profile of FeNiO-250-16 was almost identical to that of Ni foil with a main peak at 2.13 Å for the Ni—Ni path. The Fe EXAFS profile of FeNiO-250-4 of FIG. 21 showed three major peaks at 1.38, 1.96, and 2.63 Å, due to Fe—O, Fe—Cl, and second-shell Fe—Fe/Ni bonds, respectively. Yet, the feature of Fe—Cl diminished in both FeNiO_{NC}-250-4 and FeNiO-250-16. FeNiO-250-16 displayed a shorter Fe—Fe/Ni bond length (2.57 Å) than FeNiO-250-4 (3.01 Å) and FeNiO_{NC}-250-4 (3.4 Å), suggesting a possible transition from spinel structure to metallic Fe.

Results from these measurements show that prolonged heating and slow cooling facilitated the O and Cl loss for the spinel samples. Prolonged heating also promoted phase segregation of Ni into rock salt NiO or metallic form. With a deliberate control of the heating time and cooling rate, two key non-equilibrium features of the FeNiO spinel nanoparticles can be achieved, minimal Fe—Ni phase segregation, and formation of a Cl-rich surface, both critical in OER electrocatalysis (detailed below).

### Example 3

This Example describes electrochemical analysis of samples of Example 1.

Electrochemical measurements were carried out with a CHI 700e electrochemical workstation in a three electrodes configuration. The prepared carbon paper (i.e., sample of Example 1) was fixed onto a graphite electrode holder, with an exposed surface area of 1 cm². A platinum wire was used as the counter electrode and an Ag/AgCl in saturated KCl as the reference electrode. The reference electrode was calibrated against a reversible hydrogen electrode (RHE) and all potentials in the present study were referenced to this RHE.

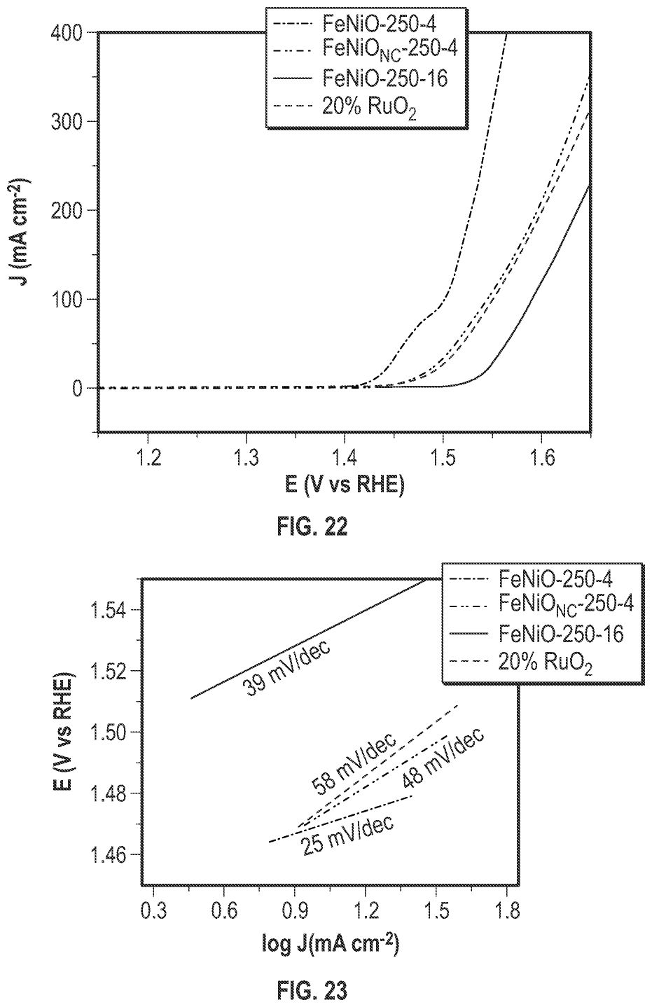

The FeNiO-250-4 sample that possessed a unique Fe—Ni oxide spinel with Cl-rich surface nanospindles exhibited a remarkably high activity towards OER. As shown in the polarization curves of FIG. 22, FeNiO-250-4 reached the high current density of 100 mA cm⁻² at an ultralow potential of 1.49 V vs RHE (corresponding to an overpotential, η₁₀₀, of about 260 mV), in comparison to 1.54 V for FeNiO_{NC}-250-4, 1.60 V for FeNiO-250-16, and 1.55 V for commercial 20% RuO₂. With reference to FIG. 23, FeNiO-250-4 also displayed a Tafel slope of only 25 mV dec⁻¹ markedly lower than the rest of the sample series, 39 m V dec⁻¹ for FeNiO-250-16, 48 mV dec⁻¹ for FeNiO_{NC}-250-4, and 58 mV dec⁻¹ for commercial RuO₂. In addition, at 100% iR compensation, FeNiO-250-4 also produced an exceedingly high current density of 1 A cm⁻² at only 1.64 V, which represents one of the best activities among the leading FeNi oxide-based OER electrocatalysts.

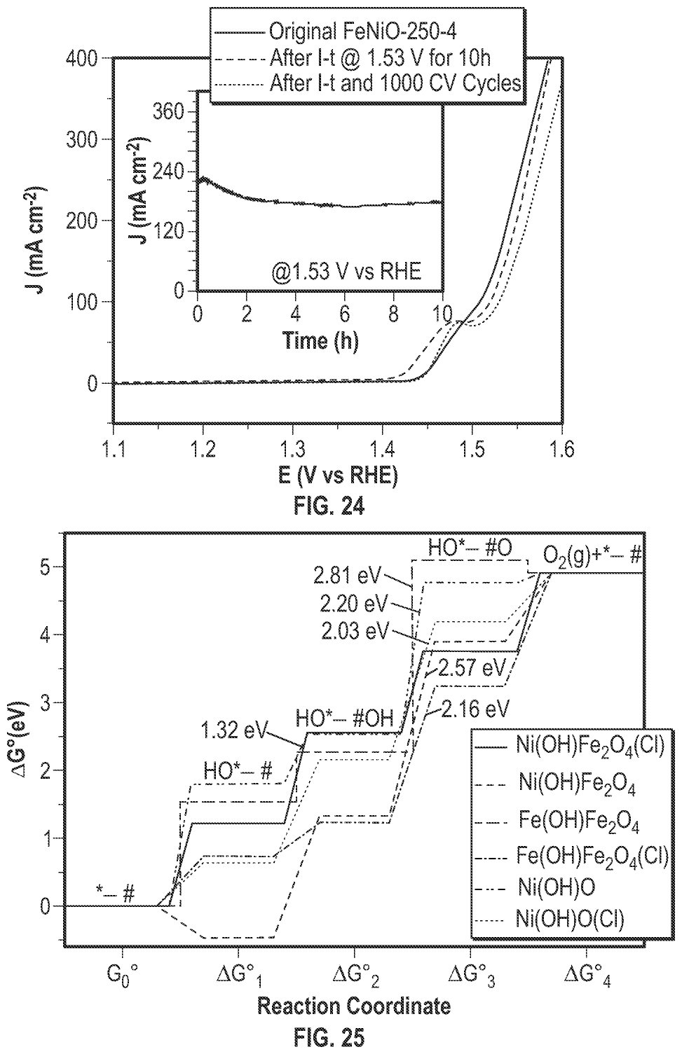

Notably, the FeNiO-250-4 sample represented the optimal condition for OER and also showed excellent stability. At the applied potential of 1.53 V, over 80% of the initial current was retained even after 10 hours of continuous operation as shown in the inset of FIG. 24, which is one of the best performances as compared to the state of the art OER catalysts. The corresponding OER polarization curve of FIG. 24 showed an anodic shift of only 10 mV. When the electrode was subject to another 1,000 cyclic voltammetric cycles between 1.20 and 1.65 V, the subsequent polarization curve exhibited a further anodic shift of only 10 mV.

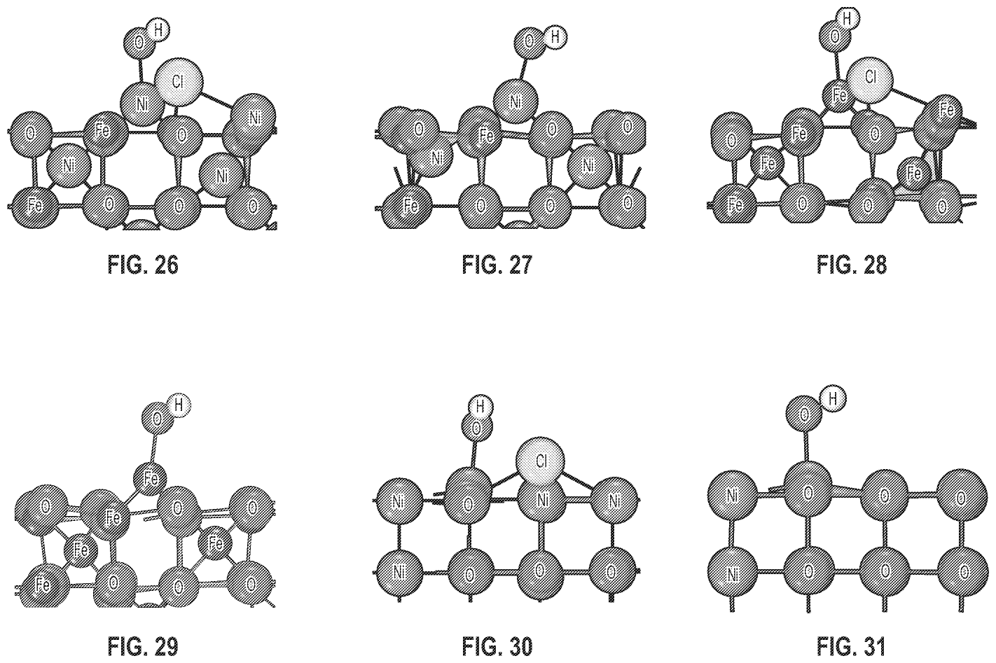

To unravel the mechanistic origin of the remarkable OER activity observed above with FeNiO-250-4, slab models of a crystal surface were built by chlorine substitution of the surface oxygen atom originally located between Fe_{oct} (octahedral site) and Ni_{td} (tetrahedral site) in NiFe₂O₄(100) (FIG. 26), based on the structural features identified in the above experimental characterization.

Spin-polarized density functional theory (DFT) calculations were carried out using the VASP (Vienna Ab-Initio Simulation Package) code. Projector-augmented wave (PAW) method with the Perdew-Burke-Ernzerhof (PBE) exchange-correlation functional was used in all calculations. On-site Coulomb interactions were corrected within the DFT+U framework based on Dudarev's approximation. U_{eff}=4.20 and 6.40 for Fe and Ni, respectively, were used. Plane-wave basis set with a 400 eV energy cutoff provides a balance of accuracy and computational cost. Either quasi-Newton scheme or conjugate gradient algorithm implemented in VASP was used to relax structure until forces are converged to less than −0.3 eV Å⁻¹ on unconstrained atoms and self-consistent convergence until 10⁻⁵ eV. The Gaussian smearing with a σ value of 0.5 was used to minimize entropy contribution to free energy. The bulk structure of NiFe₂O₄ was taken from JCPDS (JCPDS Card No. 10-0325) and optimized in (4×4×1) k-point grid sampling of the surface Brillouin zone. The optimized lattice constant of 8.37 Å was found in close agreement with the experimental value of 8.35 Å.

A supercell consisting of five layers of NiFe₂O₄ with an exposed (100) surface was constructed from the optimized bulk structure. A vacuum space of 14 Å in z-direction was inserted between the slabs, and the atoms in the top three layers were allowed to relax while those in the bottom two layers were fixed at the corresponding bulk position during structural optimization.

Free energy calculations indicate that adsorption of OH favors the Ni_{td} sites over the Fe_{oct} sites on the surface, consistent with the XPS results (FIG. 15-17). Consequently, the NiFe₂O₄ (100) surface with Cl substituting O and Nita binding an OH (Ni(OH)Fe₂O₄(Cl) (FIG. 26), was used as the model catalyst. Other structures, Ni(OH)Fe₂O₄(FIG. 27), Fe(OH)Fe₂O₄(Cl) (FIG. 28), Fe(OH)Fe₂O₄(FIG. 29), Ni(OH)NiO(Cl) (FIG. 30) Ni(OH)NiO (FIG. 31) were constructed as comparative references.

A two-site (*- #) model was adopted to study the OER mechanism. Generally, a single active site mechanism, shown in eq. S1-S4, has been widely used in analyzing oxygen evolution reaction (OER) catalyzed by an oxide catalyst, such as Ni, Co, Fe spinels.

*+OH→*—OH (S1)

*—OH+OH→*—O+H₂O (S2)

*—O+OH→*—OOH (S3)

*—OOH+OH→O₂+*+H₂O (S4)

On the NiFe₂O₄ catalyst, Ni was considered as the active site for OER and the potential limiting step was *—O→*—OOH (eq. S3). This step has a reaction free energy of 2.0 eV, corresponding to a thermodynamic overpotential of approximately 770 mV. Based on the scaling relationship between the binding energies of *OH and *OOH, an overpotential less than 0.4 V cannot be achieved by following the single metal site mechanism. Therefore, the mechanism based on a single metal site was not believed to contribute to the high activity observed in the present study.

A mechanism involving two adjacent metal sites, i.e., *- #, was adopted. According to this mechanism, shown in eq. S5-S8, OER starts by OH binding on the first metal site forming HO*—#(ΔG₁^{∘}, eq. S5). This is followed by a second OH binding at the neighboring metal site forming HO* #OH (ΔG₂^{∘}, eq. S6). A stepwise reaction of HO* #OH with OH (ΔG₃, eq. S7 and ΔG₄^{∘}, eq. S8) releases O₂ and H₂O and completes the cycle.

*-#+4(OH⁻h⁺)→HO*—#+3(OH⁻+h⁺)⁻ΔG₁^{∘} (S5)

HO*—#+3(OH⁻+h⁺)→HO*—#OH+2(OH⁻+h⁺)ΔG₂^{∘} (S6)

HO*—#OH+2(OH⁻+h⁺)→HO*#O+H₂O+(OH⁻+h⁺)ΔG₃^{∘} (S7)

HO*—#O+H₂O+(OH⁻+h⁺)→*-#+O₂+2H₂OΔG₄^{∘} (S8)

The reaction free energies of these steps were calculated according to eq. S5-S8. Based on the calculated reaction free energies, the reaction free energy profile shown in FIG. 25 was constructed and was used to determine the thermodynamic overpotential.

The reaction free energy expressions for the reactions described in eq. S5-S8 are:

ΔG₁^{∘}=μ(HO*—#)+3μ(OH⁻+h⁺)−μ(*-#)−4μ(OH⁻+h⁺) (S9)

ΔG₂^{∘}=μ(HO*—#OH)+2μ(OH⁻+h⁺)−μ(HO*—#)−3μ(OH⁻+h⁺) (S10)

ΔG₃^{∘}=μ(HO*—#O)+μ(H₂O)+μ(OH⁻+h⁺)−μ(HO*—#OH)−2μ(OH⁻+h⁺) (S11)

ΔG₄^{∘}=4.92−(ΔG₁^{∘}+ΔG₂^{∘}+ΔG₃^{∘}) (S12)

Since PBE significantly overestimates μ(O_{2(g)}), ΔG₄^{∘} in eq. S12 was computed on the basis of the experimental reaction free energy of 4.92 eV for 2H₂O₍ₗ₎→2H_{2(g)}+O_{2(g)}. The chemical potential of OH, i.e., μ(OH⁻+h⁺), was computed using an approach based on CHE. Free energies of all intermediates were determined using G^{∘}=E_{elect}^{∘}−TS+ZPE. E_{elect}^{∘} was obtained from DFT calculations, whereas the contributions of TS and ZPE were computed from frequency calculations in which adsorbate together with the atoms in the topmost layer were allowed to move.

From the free energy diagram of FIG. 25, Ni(OH)Fe₂O₄(Cl) displayed a thermodynamic overpotential of only 90 mV and stood out as the optimal catalyst for OER among all models. The potential-limiting step is the second OH adsorption with a reaction free energy (ΔG₂^{∘}) of 1.32 eV, while all other steps, including the first OH binding (ΔG₁^{∘}), O—O coupling (ΔG₃^{∘}), and O₂ release (ΔG₄^{∘}), have a reaction free energy equal to or slightly lower than 1.23 eV. For comparison, Ni(OH)Fe₂O₄ with a similar structure but without Cl substitution, shows a very high reaction free energy for the O—O coupling step (ΔG₃^{∘}), whereas ΔG₁^{∘}, ΔG₂^{∘}, and ΔG₄^{∘} are all markedly below 1.23 eV. The high reaction free energy of O—O coupling accompanied by proton extraction (ΔG₃^{∘}) indicates that this step is the potential limiting step. These results suggest that incorporation of Cl onto the surface of NiFe₂O₄ spinel enhances the OER activity by facilitating O—O bond formation.

With continued reference to FIG. 25, the potential energy profiles of OER on the monometal systems of Fe(OH)Fe₂O₄, Fe(OH)Fe₂O₄(Cl), Ni(OH)NiO and Ni(OH)NiO(Cl) was mapped to confirm that the active site ensemble on Ni(OH)Fe₂O₄(Cl) was unique and responsible for the enhanced activity, where the O—O coupling step, with a respective reaction free energy of 2.81, 2.16, 2.20 and 2.3 eV, remains to be the potential limiting step. These results indicate that these monometal systems, even with Cl substitution, exhibited only a limited OER activity. Therefore, the remarkable activity of FeNiO-250-4 is most likely a synergistic effect of the formation of the metastable Fe—Ni spinel phase and the incorporation of Cl in the surface by substituting surface oxygen atom.

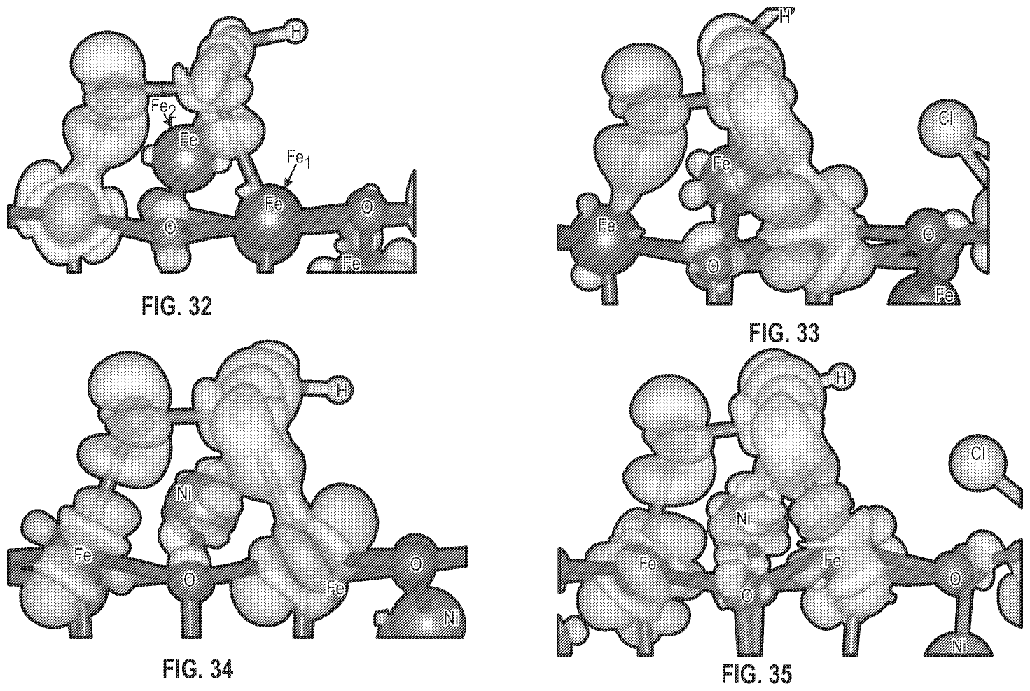

To understand the enhanced OER activity in Ni(OH)Fe₂O₄(Cl), charge density differences were tracked and compared the bond distances of the O* #OH species on Fe(OH)Fe₂O₄, Fe(OH)Fe₂O₄(Cl), Ni(OH)Fe₂O₄ and Ni(OH)Fe₂O₄(Cl). With reference to FIG. 32, for O*— #OH adsorbed on Fe(OH)Fe₂O₄, there was no observable charge density redistribution at the Fe₁ site (adjacent to Cl) but a significant electron depletion was observed on Fe₂ (away from Cl). With reference to FIG. 33, with the introduction of Cl, charge redistribution at Fe₁ is clearly visible whereas the electron density redistribution at Fe₂ was minimal. The electron density redistribution was believed to stabilize the O—O species on Fe(OH)Fe₂O₄(Cl) as a result of losing the proton by O—O—H. With reference to FIG. 34, replacing Fe with Ni results in a relatively uniform charge density redistribution at both Fe₁ and Fe₂ sites and further stabilized the O—O species on Ni(OH)Fe₂O₄. Therefore, with reference to FIG. 35, the presence of Cl and Ni strengthens bonding between the O*— #OH species and lowers the reaction free energy of the O—O coupling step.

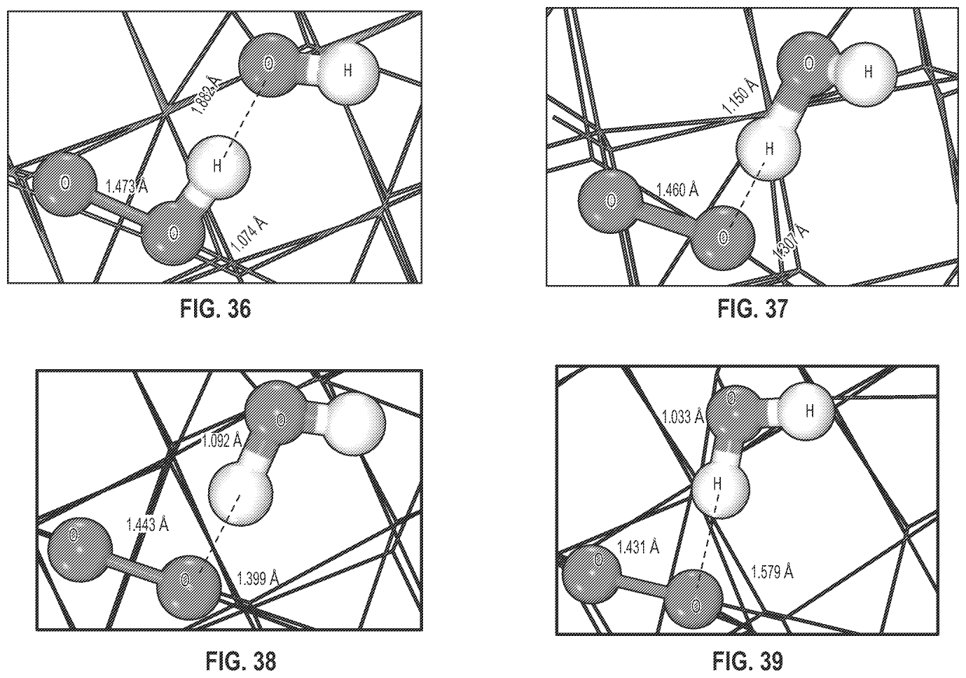

Charge redistribution at the Fe₁ and Fe₂ sites was also reflected in part in the decrease of Bader charge of the O—O pair, which was −1.2|e|, −1.14|e|, −1.4|e| and −1.0|e| for the O—O pair adsorbed on Fe(OH)Fe₂O₄, Fe(OH)Fe₂O₄(Cl), Ni(OH)Fe₂O₄ and Ni(OH)Fe₂O₄(Cl), respectively. A decreased negative charge value indicates an increase of acidity of O*— #OH, which benefits the proton transfer from O*— #OH to the OH adsorbed on Nita or Feta (FIGS. 36-39). A complete proton transfer from HO*—#O species to the OH facilitates the O—O bond formation, and the O—H distance in HO*—#O increases from 1.074 Å on Fe(OH)Fe₂O₄ to 1.307 Å on Fe(OH)Fe₂O₄(Cl), further to 1.399 Å on Ni(OH)Fe₂O₄, and finally to 1.579 Å on Ni(OH)Fe₂O₄(Cl) (FIGS. 36-39). Correspondingly, this increasingly detached proton approaches the OH on Nita or Feta to form H₂O. The loss of H from HO*— #O also strengthens the O—O bond, as the bond distance decreases from 1.473 Å on Fe(OH)Fe₂O₄ to 1.431 Å on Ni(OH)Fe₂O₄(Cl). In summary, the presence of Ni and Cl in the catalyst synergistically stabilized the O—O species while facilitated proton transfer from HO*—#O to the adjacent OH, resulting in a much-reduced free energy barrier for the O—O coupling step.

Magnetic induction heating and rapid quenching was exploited for the rapid fabrication of metal oxide spinel nanostructures. Using NiCl₂ and FeCl₃ as the precursors, FeNi oxide spinels were obtained by heating at controlled currents within seconds and exhibited an even mixing of the Ni and Fe elements and a Cl-rich surface, in sharp contrast to samples prepared at prolonged heating and/or natural cooling in the ambient. The best sample, FeNiO-250-4 needed an overpotential of only 260 mV to reach the high current density of 100 mA cm⁻² and exhibited significant stability in alkaline media. Such a remarkable activity was attributed to the unique metastable structure that facilitated the adsorption of key reaction intermediates and O—O coupling, a major limiting step in OER. Results from this study highlight the unique advantages of MIHRQ in the facile production of unprecedented material structures that are unattainable in conventional thermal processes for enhanced electrocatalytic performance and potential applications in the structural engineering of a diverse range of materials.

### Example 4

This example describes synthesis of Ru nanoparticle catalyst composition as shown in FIG. 40.

Ruthenium (III) chloride (RuCl₃) hydrate (RuCl₃·XH₂O, 35-40%, ACROS Organics), was dissolved in acetone (from Fisher chemicals) to form a solution at a concentration of about 20 mg mL⁻¹. Carbon paper (from TGP-H-90, Toray) was thermally treated in a Muffle furnace at 500° C. in ambient atmosphere for about 1 h to increase surface wettability, cut into 1×2 cm² pieces, and rinsed with acetone several times.

Approximately 100 μL of the solution of RuCl₃ was first dropcast onto a piece of pretreated carbon paper and then dried at room temperature for 10 min. After drying in air for 30 min, the carbon paper was wrapped in graphite paper (0.01 mm thick) before being sandwiched between two iron sheets (2.5 cm×2.5 cm×0.01 mm) to prevent direct contact of the samples to the iron sheets to prevent Fe contamination at high temperature.

The assembly was placed into the middle of an induction coil of a magnetic induction heater (FIG. 1) having a four-turn induction coil with a diameter of 5 cm. Magnetic induction heating was carried out at a controlled current (from about 200 to about 600 A) for a select heating time (from about 3 seconds to about 12 seconds).

A series of samples were prepared with the MIHRQ setup at a controlled induction current (X=200-600 A) for a select period of time (Y=3-12 s) and referred to hereinafter as Ru-X-Y, in particular Ru-200, Ru-300, Ru-400, Ru-600, which were heated for 6 seconds, Ru-300-S heated for 3 seconds, and Ru-300-L heated for 12 seconds.

After heating was completed, the sample was dropped into an ethanol-dry ice solution (−78° C.) placed underneath the induction coil for rapid quenching to cool the sample and to prevent oxidation in the air.

By virtue of the Joule effect, the iron sheets were heated up at an ultrafast rate (over 100 K s⁻¹) owning to the Eddy current generated instantly by the magnetic field. As a thermal-radioactive material, carbon paper was heated up simultaneously, converting RuCl₃ into Ru nanoparticles supported on carbon paper.

### Example 5

This Example describes structural characterization of samples of Example 4.

Structural characterization was carried out using TEM experiments, which were conducted with a Tecni G2 transmission electron microscope operated at about 200 keV. X-ray photoelectron spectroscopy (XPS) measurements were carried out with a Thermo Fisher K-alpha system, where the binding energy was calibrated against the C 1s binding energy. Raman measurements were conducted using a Horiba Jobin Yvon LabRAM ARAMIS automated scanning confocal Raman microscope under 532 nm excitation. X-ray absorption spectroscopy (XAS) measurements were carried out at 10 K on beamline 4-1 of the Stanford Synchrotron Radiation Lightsource using an Oxford liquid helium cryostat.

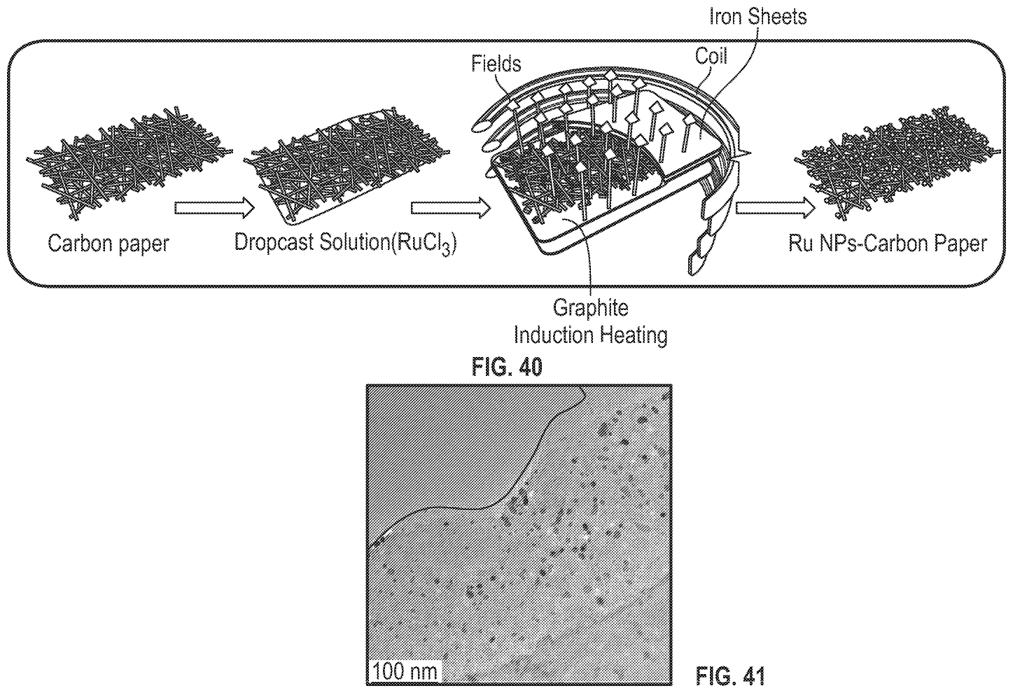

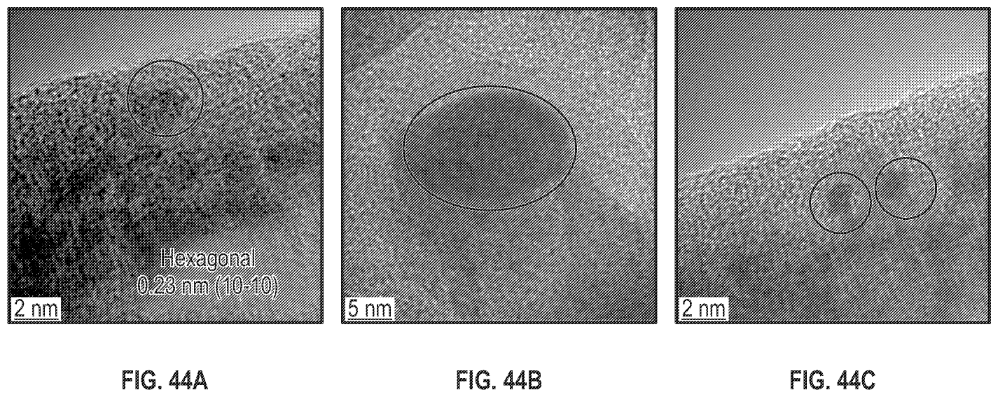

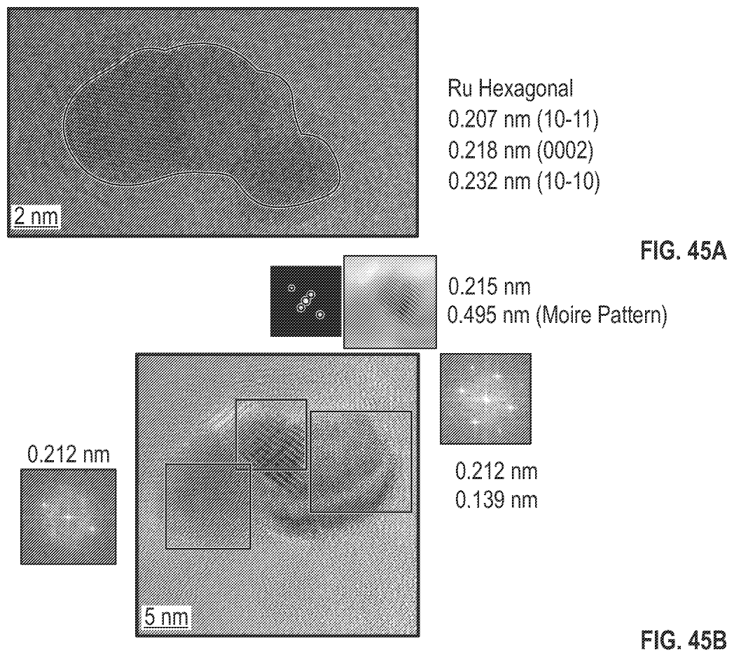

The structure of the samples was first characterized by TEM measurements. FIGS. 41-46C illustrate a structural evolution of the ruthenium species from an amorphous state to metallic ruthenium nanoparticles with increasing magnetic current. For Ru-200, which was prepared by MIHRQ treatment at 200 A for 6 s, the sample contained mostly amorphous particles (2-5 nm in diameter), as manifested in bright-field TEM measurements (FIGS. 44A-C). This was likely because the temperature was not sufficiently high for complete decomposition of RuCl₃ and for the production of crystalline nanoparticles.

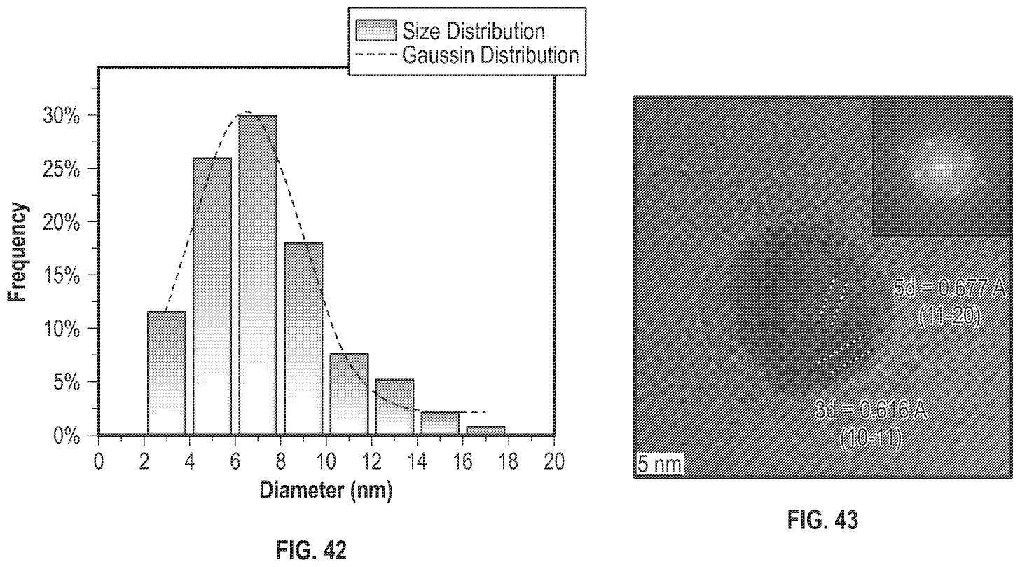

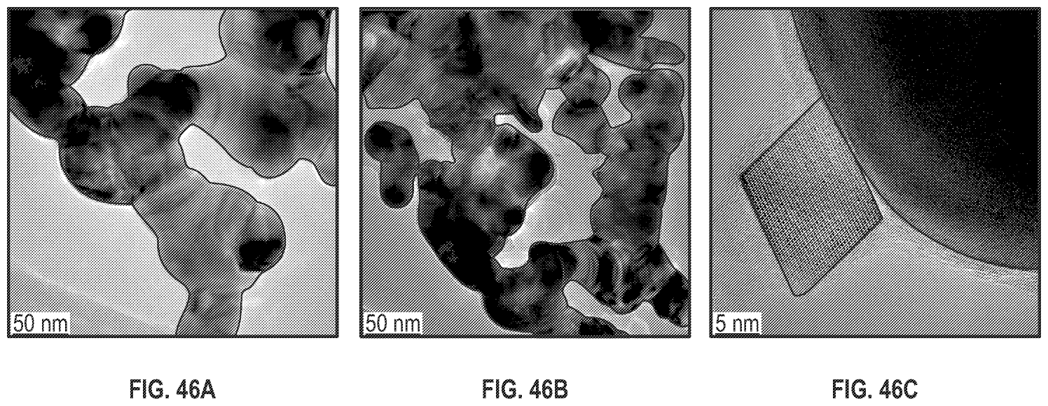

When the magnetic current was increased to 300 A, the corresponding sample, Ru-300 (FIG. 41), resulted in nanoparticles being evenly distributed on the carbon paper. Most of the nanoparticles were from about 2 to about 10 nm in diameter (FIG. 42), with an average size of 6 nm. Additionally, clearly defined lattice fringes were resolved from these nanoparticles in high-resolution TEM measurements (FIG. 43), with two interplanar spacings of approximately 0.135 nm and 0.205 nm that can be ascribed to the Ru (11-20) and (10-11) facets (JCPDS-ICDD card No. 06-0663), respectively. The good crystallinity of the nanoparticle was evidenced in the bright spots of the fast Fourier transform of the TEM image, as shown in the inset of FIGS. 43 and 46A-C, suggesting the formation of hcp Ru nanoparticles. At even higher magnetic current (e.g., Ru-600, FIG. 46A-C), apparent aggregation of crystalline Ru occurred forming large agglomerates.

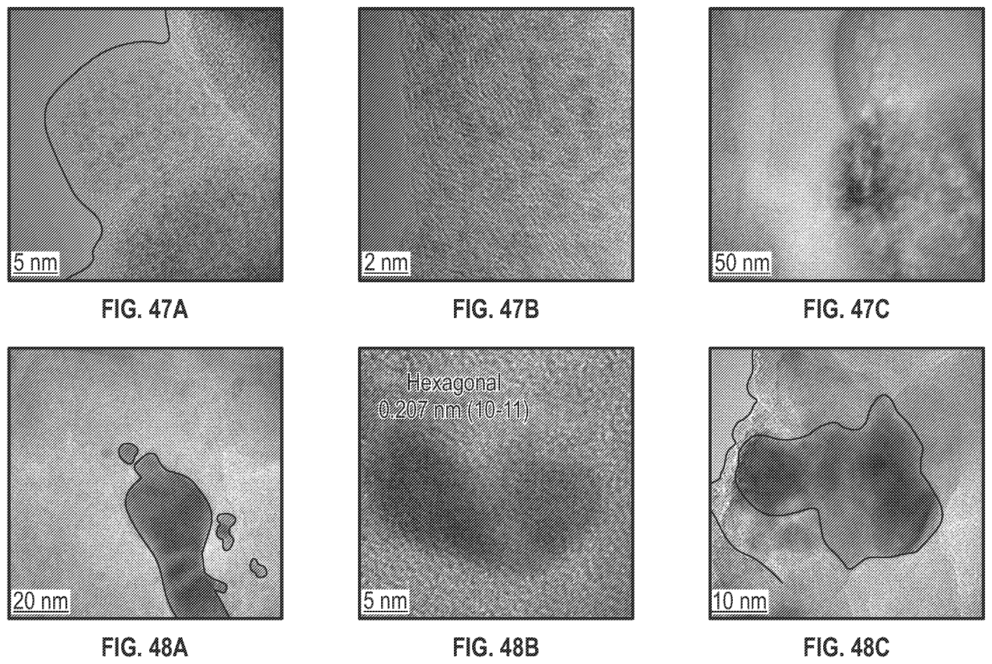

The sample morphology was also readily manipulated by adjusting the heating time. When the heating time was reduced to 3s (Ru-300-S), only amorphous particles were produced on carbon (FIG. 47A-C); yet with the heating time prolonged to 12 s (Ru-300-L), the sample consisted mostly of hcp Ru agglomerates (FIG. 48A-C). Thus, Ru-300, which was prepared at 300 A and 6 s may represent the optimal conditions to produce hcp Ru nanoparticles that were well dispersed on the surface of carbon paper.

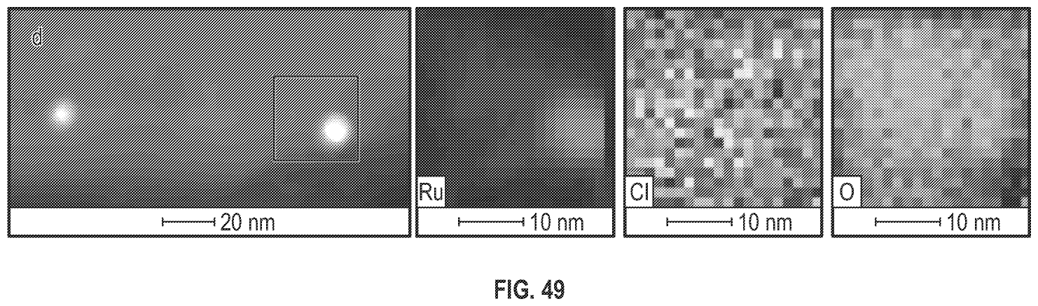

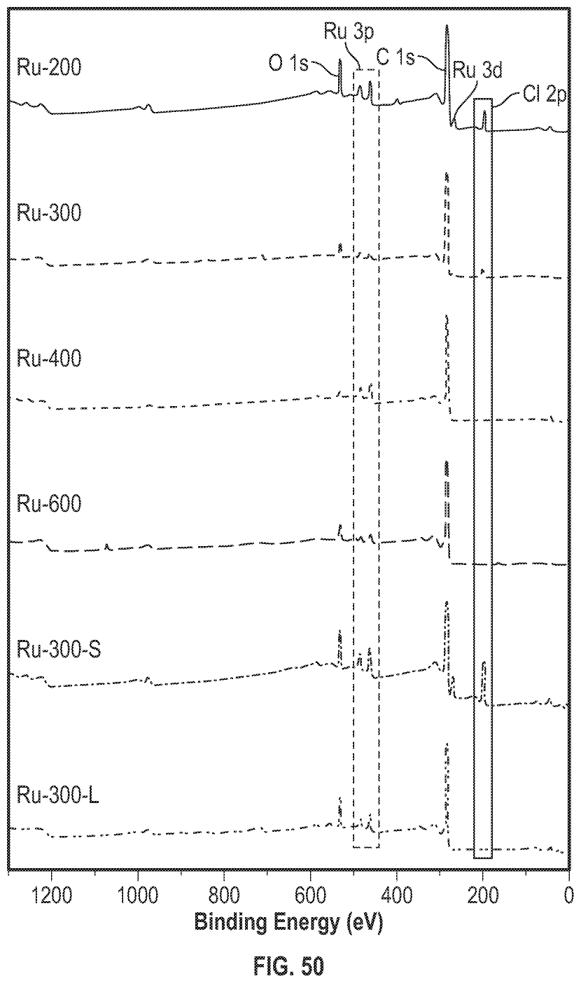

Elemental mapping analysis based on electron energy loss spectroscopy (EELS) measurements also showed that Ru was mostly confined within the nanoparticles, with residual O and Cl (FIG. 49). Indeed, these elements can also be identified in X-ray photoelectron spectroscopy (XPS) measurements. From the XPS survey spectra in FIG. 50, the Ru 3d, C 1s, Ru 3p, and O 1s peaks can be clearly resolved in approximately 280, 284, 474, and 530 eV, respectively, in all the samples. Notably, the Cl 2p peak (approximately 200 eV) can also be seen in some of the samples that were prepared at relatively low currents for a short heating time, such as Ru-200, Ru-300 and Ru-300-S, suggesting the formation of residual Cl. By sharp contrast, the Cl 2p peak vanished in samples prepared by prolonged heating at a higher current, such as Ru-400, Ru-600 and Ru-200, implying complete decomposition of RuCl₃ into Ru nanoparticles.

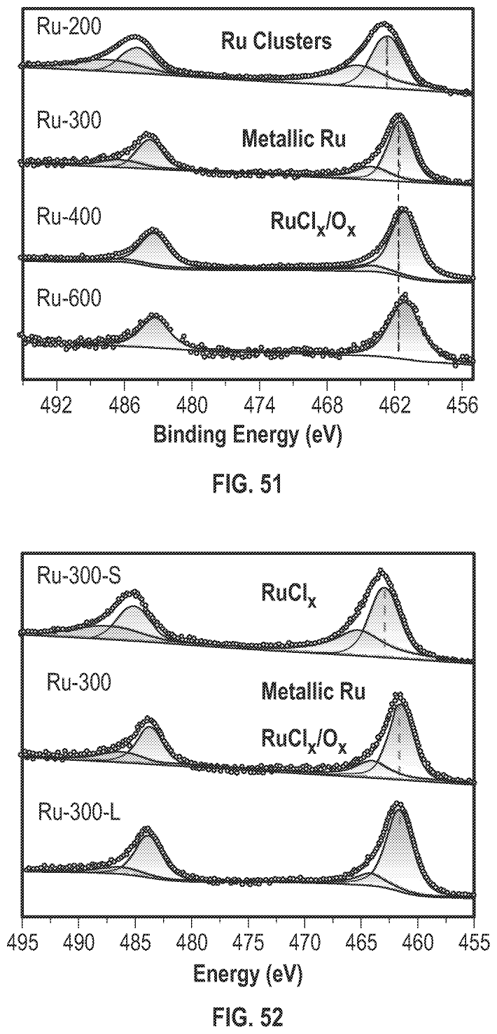

FIG. 51 shows high-resolution scans of the Ru 3p electrons in the series of samples prepared at different magnetic currents (200 to 600 A) and same heating time of 6 s. It was observed that the Ru-600 sample consisted of a single doublet at 461.1/483.3 eV arising from the 3p_{3/2}/3p_{1/2} electrons of metallic Ru, consistent with results from TEM measurements where large agglomerates of crystalline Ru were found (FIG. 46A-C).

For Ru-400 that was prepared at a lower magnetic current, in addition to the metallic Ru 3p_{3/2}/3p_{1/2} pair at 461.2/483.4 eV, a small, second doublet was also resolved at 463.9/485.1 eV, signifying the formation of electron-deficient Ru likely in the forms of RuClₓ/RuO_{y} species. These latter became more pronounced in Ru-300 (464.1/486.3 eV), with the corresponding metallic peaks at 461.6/483.8 eV. Ru-200 exhibited an even more prominent doublet for the RuClₓ/RuO_{y} species though at a binding energy about 0.8 eV higher at 465.3/487.5 eV. The other doublet was deconvoluted at 462.7/484.9 eV, which were at least 1.1 eV higher than those of the other samples in the series but markedly lower than those of RuCl₃ (464.1 eV for Ru 3p_{3/2}), suggesting only partial decomposition of RuCl₃ and the formation of amorphous Ru nanoclusters as observed in TEM measurements (FIGS. 41-43). In fact, on the basis of the integrated peak areas, a clear decline of the relative content was observed of the RuClₓ/RuO_{y} species in total Ru with increasing magnetic current, Ru-200 (49.7%)>Ru-300 (29.3%)>Ru-400 (11.5%)>Ru-600 (0%).

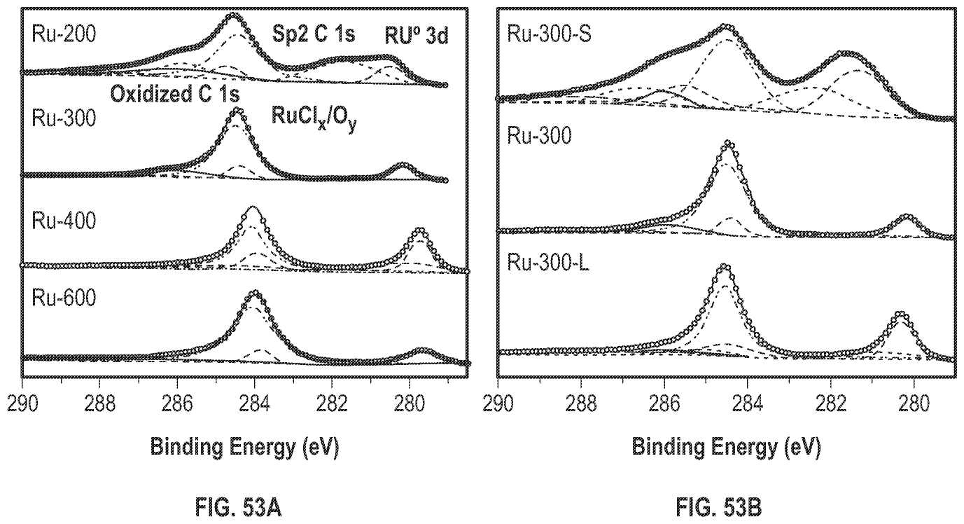

A similar trend was observed when the heating duration was increased at a fixed magnetic current. With reference to FIG. 52, the binding energies of the Ru 3p_{3/2}/3p_{1/2} peaks decreased by about 1.3 eV from Ru-300 to Ru-300-S and Ru-300-L, and the fraction of the RuClₓ/RuOₓ species diminished accordingly, Ru-300 (45.5%)>Ru-300 (29.3%)>Ru-400 (17.8%). It was be noted that in comparison with Ru-200, the Ru 3p_{3/2}/3p_{1/2} binding energies of Ru-300-S were about 0.3 eV higher, implying an even lower degree of decomposition of RuCl₃ into Ru nanoparticles. That is, prolonged heating facilitated the formation of metallic Ru nanoparticles, consistent with the TEM results (FIGS. 41-48C). The corresponding Ru 3d profiles were also in agreement (FIG. 53).

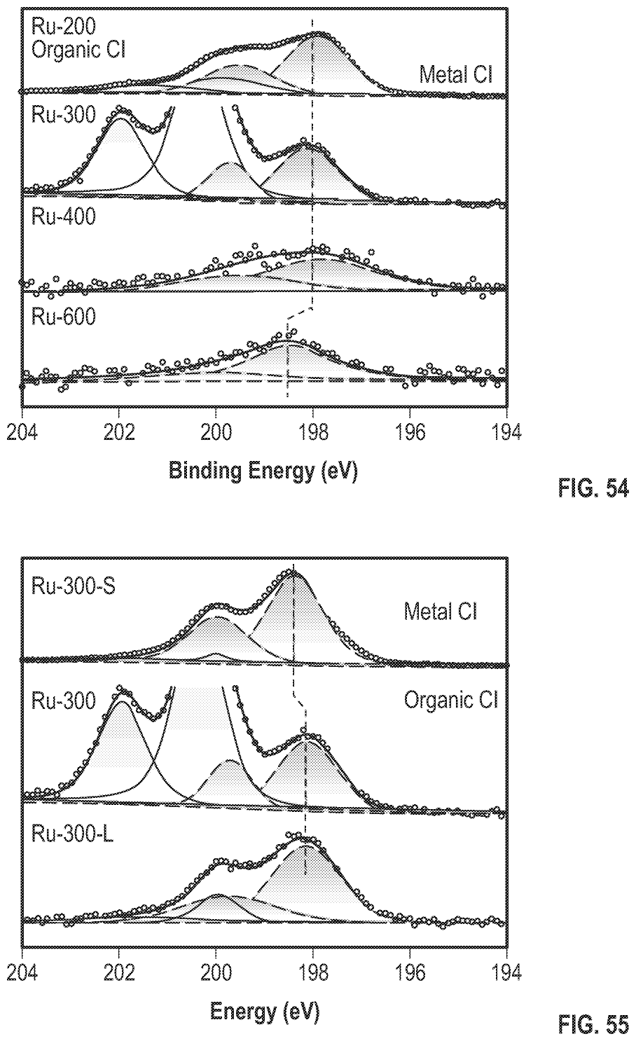

Consistent results were obtained from the Cl 2p spectra. With reference to FIG. 54, Ru-200, Ru-300, and Ru-400 all possessed a doublet at 198.0/199.6 eV that can be assigned to Ru—Clₓ. For Ru-600, this doublet appeared at a higher binding energy by (about 0.5 eV) suggesting weakened interaction between Cl and Ru, due to structural hinderance by a thin carbon shell, as overserved in TEM measurements (FIG. 48A-C). For Ru-200 and Ru-300, a second doublet emerged at 200.0/201.6 eV that was ascribed to organic Cl (i.e., C—Clₓ or O—Clₓ species), which vanished altogether in Ru-400 and Ru-600, implying thermal instability of the organic Cl species. Furthermore, the content of Ru—Clₓ diminished appreciably with increasing magnetic current, Ru-200 (6.24%)>Ru-300 (0.96%)>Ru-600 (0.47%)>Ru-400 (0.35%). This showed almost complete decomposition of RuCl₃ into Ru nanoparticles at a current greater than 400 A for a heating time of 6 seconds. A similar trend was observed when the magnetic current was fixed at 300 A, with the heating time increased from 3 seconds (Ru-300-S) to 12 seconds (Ru-300-L), which led to a clear diminishment of the organic Cl species, and Ru—Clₓ being the increasingly dominant component in the sample (FIG. 55).

The C 1s and O 1s spectra of the samples series also provide important insights into the structural changes during the ultrafast heating process. As seen in FIGS. 53A-B, with increased magnetic current, the main C 1s peak decreased from about 284.4 eV for Ru-200 and Ru-300 to about 284.1 eV for Ru-400 and Ru-600, implying that the carbon substrate was somewhat electron-deficient at low currents.

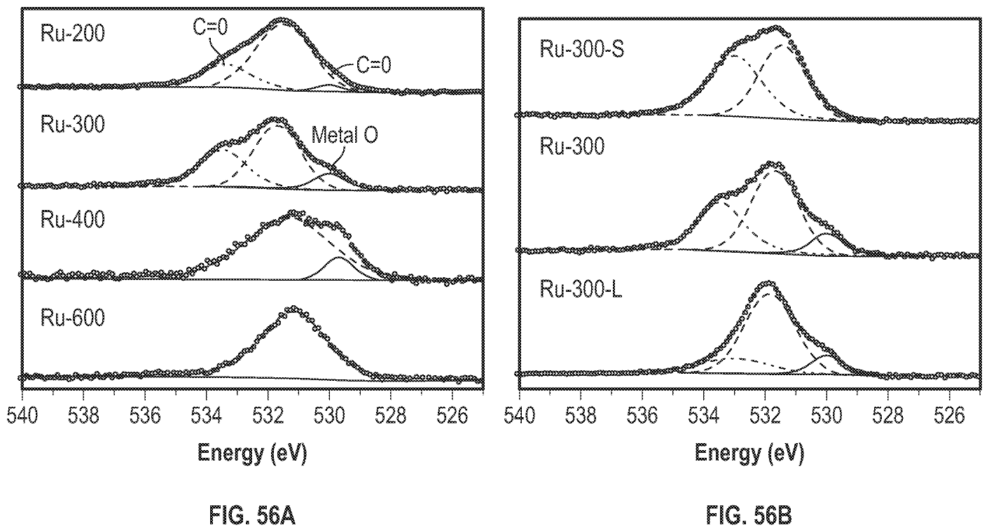

With reference to FIGS. 56A-B, which show the O 1s spectra, the major species observed were C—O (533.5 eV) and C—O (531.5 eV) moieties on carbon paper. With increasing magnetic current (and temperature), the C═O peaks diminished in intensity, and the overall O content decreased from 14.5% for Ru-200 to approximately 7% for other samples prepared at higher magnetic currents. The decomposition of these oxygen groups produced CO and/or CO₂, facilitating the carbothermal reduction of RuClₓ to ruthenium nanoparticles and protection against oxidation. Yet, with a prolonged heating duration, the overall content of O increased from 7.3% for Ru-300 to 11.3% for Ru-300-L (FIG. 56). Notably, for Ru-200, Ru-300, and Ru-400, there was a minor peak at 530.0 eV suggesting the formation of RuOₓ species on the surface (it is unlikely to be bulk RuO₂ as no RuO₂ lattice fringes were observed in TEM measurements). Taken together, these results suggest the successful transformation of RuCl₃ by MIHRQ into Ru nanoparticles having RuClₓ/RuO_{y} species on the surface.

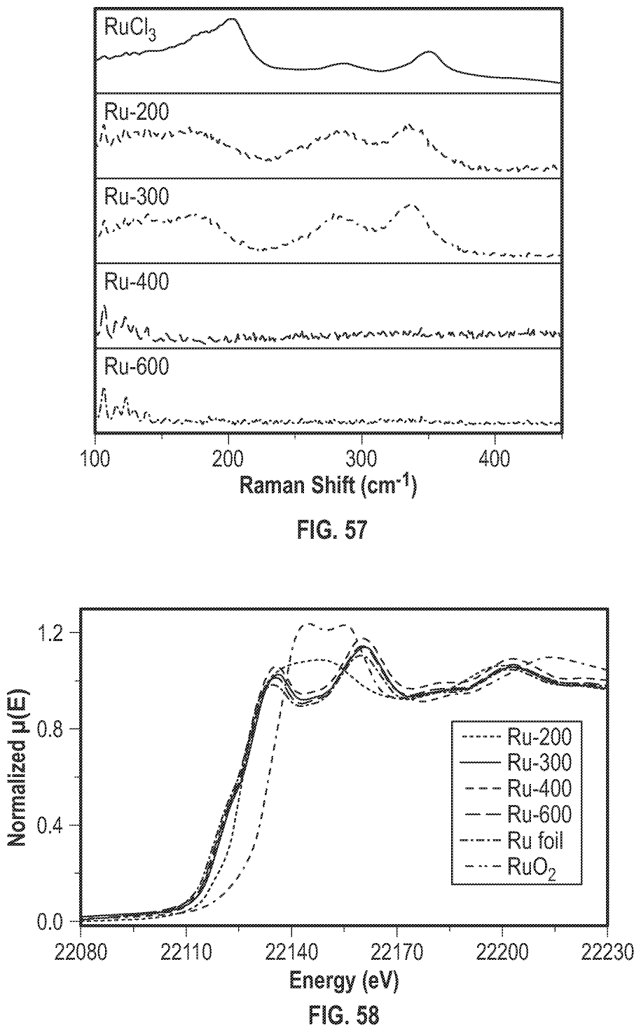

Raman measurements showed that abundant RuClₓ species were indeed formed in Ru-200 and Ru-300, but not Ru-400 or Ru-600. Raman spectra of FIG. 57 showed that RuCl₃ (on carbon paper) exhibited three major peaks at 202, 286, and 350 cm⁻¹, which may be assigned to the different Ag vibrational modes of Ru—Cl. Notably, these three bands red-shifted somewhat for Ru-200 and Ru-300 to 171, 280, and 336 cm⁻¹, respectively. This may be accounted for by the change of the stacking mode and symmetry of the Ru—Cl species in comparison to pristine RuCl₃, as a result of the decomposition of RuCl₃ during the ultrafast heating process. No apparent signals of Ru—Cl could be discerned from the spectra of Ru-400 or Ru-600, which is consistent with the complete decomposition of RuClₓ into metallic Ru in these samples, as manifested in XPS measurements.

Further structural details of the samples were obtained from X-ray absorption spectroscopy (XAS) measurements. FIG. 58 shows the X-ray absorption near-edge spectra (XANES) of the Ru K edge of the sample series. It was observed that the absorption edge of Ru-200 was situated between those of Ru foil and RuO₂, suggesting an average valence state between 0 to +4, consistent with incomplete decomposition of RuCl₃ into Ru nanoparticles, as suggested in the above XPS measurements (FIG. 51). For other samples prepared at higher magnetic currents, the absorption edges, as well as the postedge modulations, were all almost identical to that of Ru foil, confirming that metallic Ru was the dominant species in these samples, in excellent agreement with the TEM and XPS results (see e.g., FIGS. 41-43, 51, and 54). This also showed that the RuOₓ/RuCl_{y} species represent only a trace amount and were mostly residing only on the surface of Ru nanoparticles.

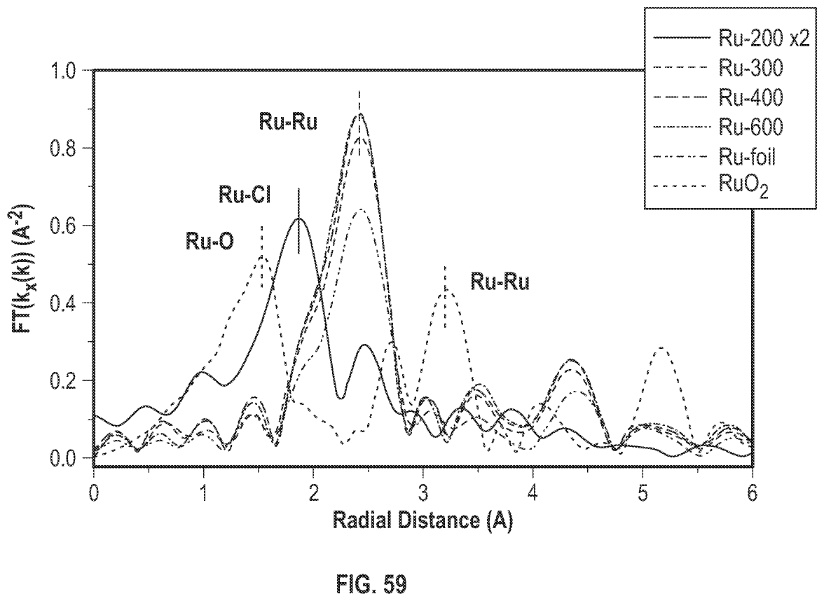

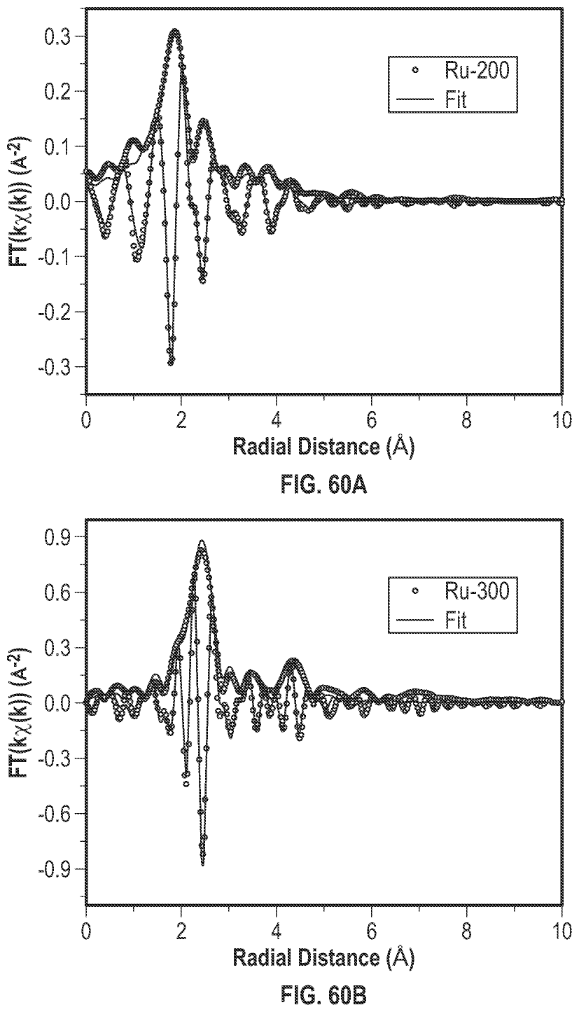

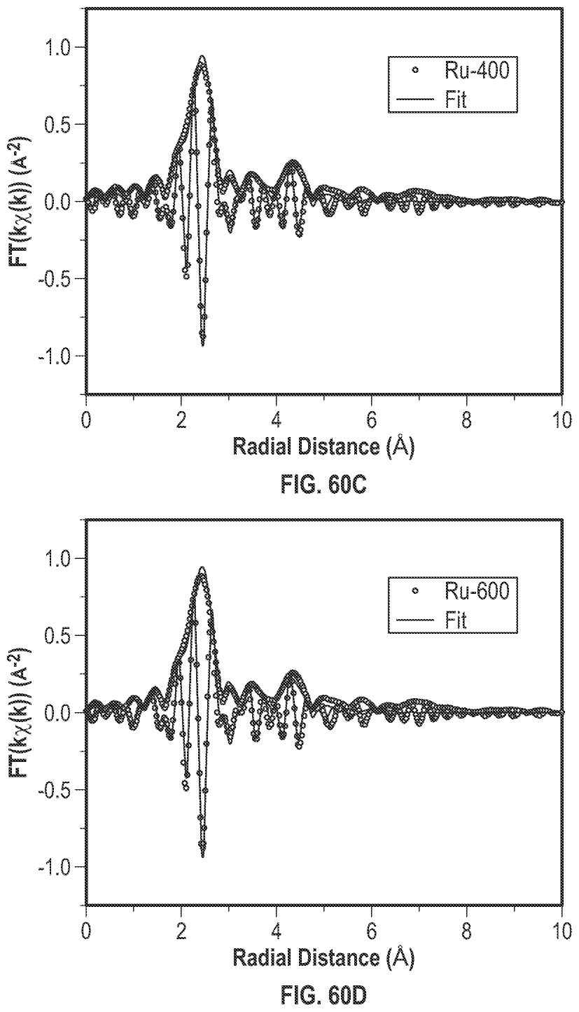

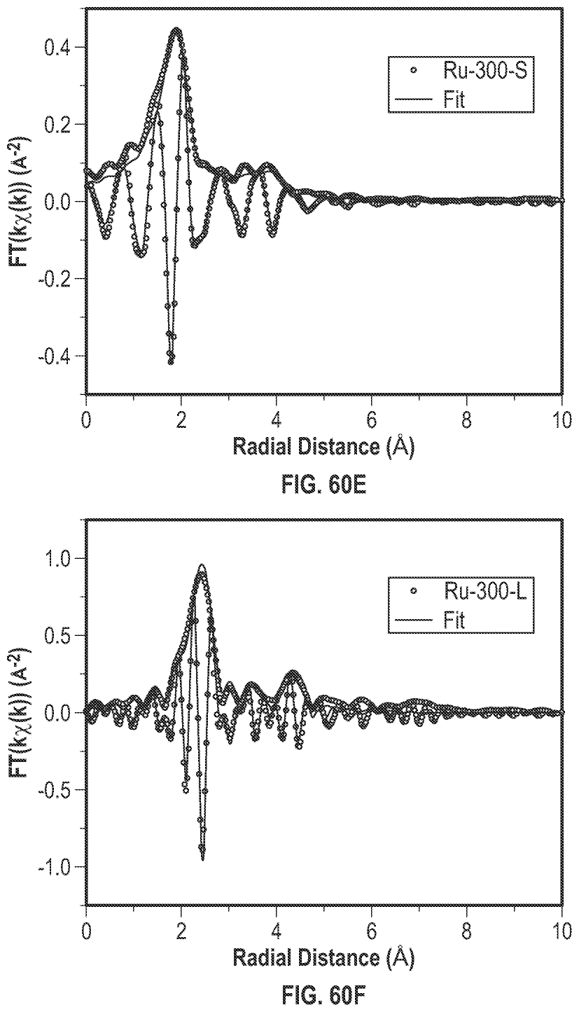

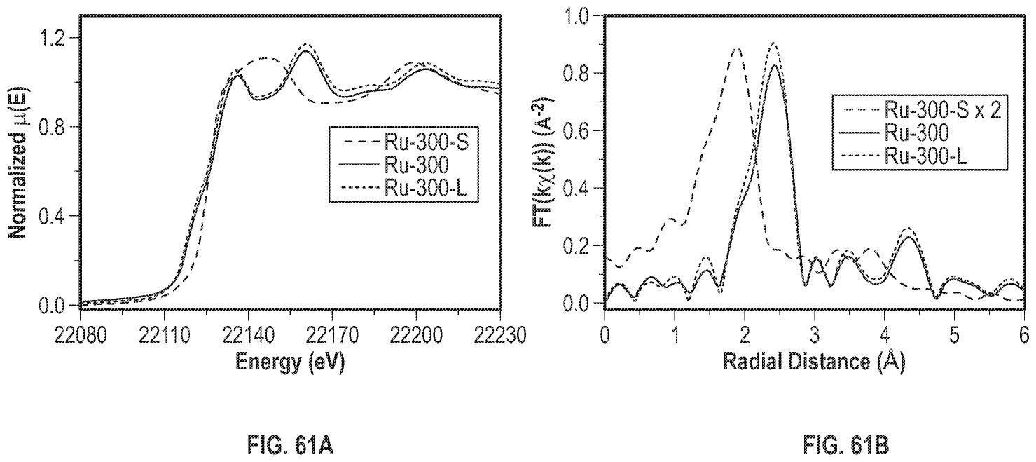

The corresponding Fourier-transformed extended X-ray absorption fine structure (FT-EXAFS) spectra of FIG. 59 showed that Ru-200 exhibited a main peak at 1.86 Å, most likely arising from the Ru—Cl path, and another at 2.48 Å to the Ru—Ru bond, which is slightly larger than that of Ru foil (2.42 Å). Fitting of the EXAFS data (FIGS. 60A-F) showed that the Ru—Cl path possessed a coordination number (CN) of 5.5 with a bond length of 2.36 Å, whereas 2.70 Å for the Ru—Ru bond with a CN of 0.95. Again, these suggest incomplete decomposition of RuCl₃ into Ru nanoclusters at 200 A for 6 seconds. For the samples prepared at higher magnetic currents (300-600 A), the main peak all appears at approximately 2.4 Å, consistent with the Ru—Ru bond in Ru foil, with a weak shoulder around 1.9 Å for the Ru—Cl bond. In addition, a small peak can be found at approximately 1.5 Å, similar to the Ru—O path of RuO₂. These observations are consistent with results from TEM and XPS measurements, where metallic Ru nanoparticles were the predominant product, and the nanoparticle surface was decorated with RuOₓ/RuCl_{y} species. Indeed, the fitting of the EXAFS data (FIGS. 60A-F) indicated that the sample structure is identical to that of the Ru foil with a Ru—Ru bond length of approximately 2.67 Å and a CN of 12. A similar structural evolution was also observed with samples prepared at 300 A but for a different heating duration (FIGS. 61A-B).

### Example 6

This Example describes electrochemical analysis of samples of Example 4.

Electrochemical measurements were carried out with a CHI 700E electrochemical workstation in a three-electrode configuration. The Ru nanoparticle carbon paper was fixed onto a graphite electrode holder, with an exposed surface area of 0.25 cm². A graphite rod was used as the counter electrode and Ag/AgCl in saturated KCl as the reference electrode. The reference electrode was calibrated against a reversible hydrogen electrode (RHE) and all potentials in the present study were referenced to this RHE.

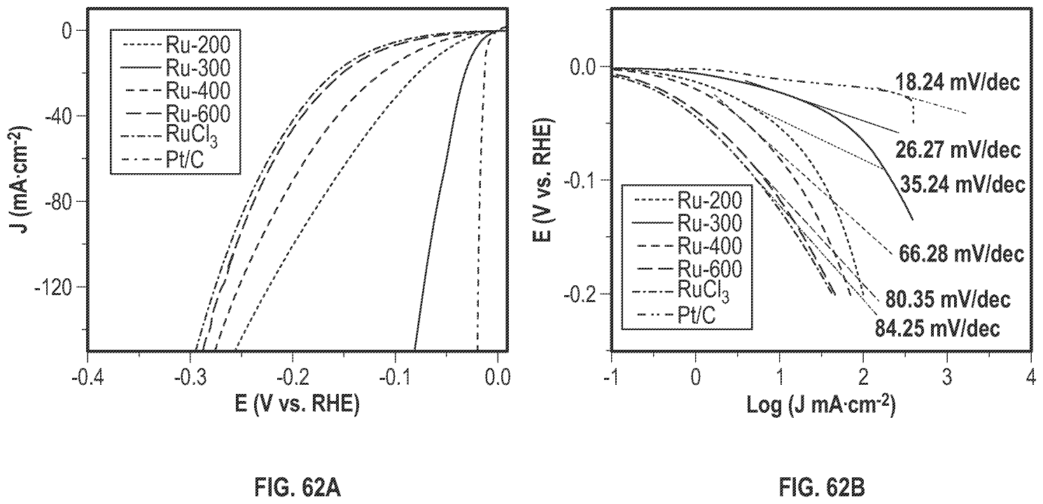

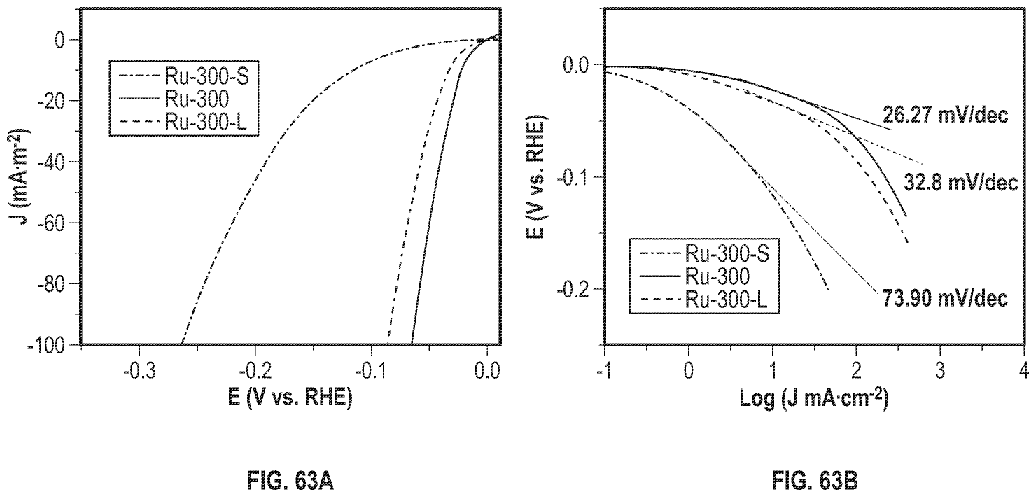

The obtained Ru nanoparticles possessed a remarkable HER activity in both acidic and alkaline media. FIGS. 62A-B show the polarization curves and corresponding Taffel plots of the Ru samples prepared under different conditions in 0.5 M H₂SO₄. It was observed that Ru-300 showed a much better activity than others with a low η₁₀ of −23 mV, as compared to −53 mV for Ru-200, −81 mV for Ru-400, −113 mV for Ru-600, −117 mV for Ru-300-S, and −33 mV for Ru-300-L. Such a performance of Ru-300 rivals that of commercial Pt/C (η₁₀=−11 mV). The corresponding Tafel plots of Ru-300 possessed the lowest slope (26 mV dec⁻¹) amongst the series, indicating a Volmer-Tafel pathway. This pathway was also likely followed on Ru-200 and Ru-300-L which featured a low slope of 35 and 33 mV dec⁻¹, respectively (see FIG. 63A-B). Nevertheless, the Tafel slope was markedly higher at 66 mV dec⁻¹ for Ru-400, 80 mV dec⁻¹ for Ru-600 and 74 mV dec⁻¹ for Ru-300-S, suggesting a more sluggish Vomer-Heyrovsky pathway instead.

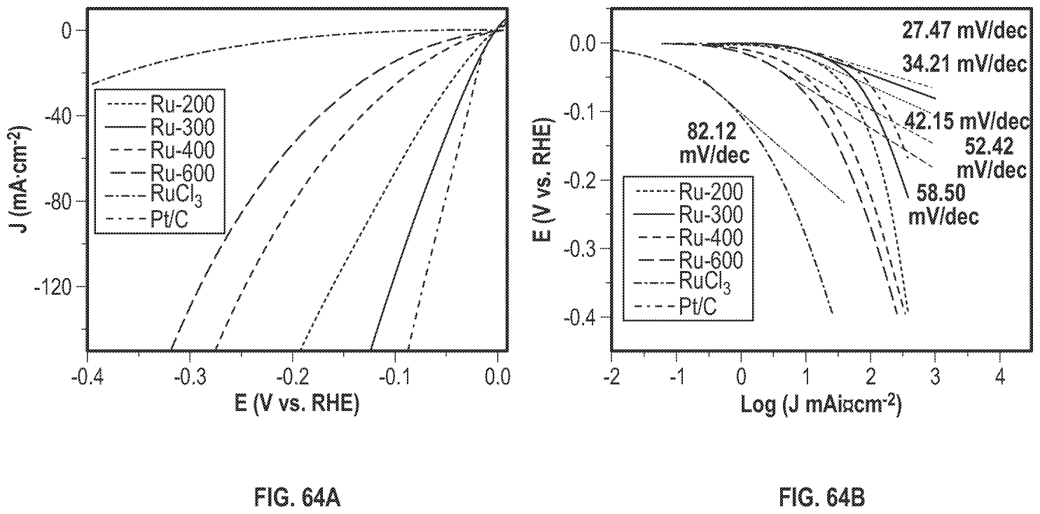

The Ru samples also exhibited outstanding HER activity in alkaline media. FIGS. 64A-B show the polarization curves and corresponding Taffel plots in 1 M KOH. The η₁₀ was observed to decrease drastically in the order of Ru-600 (η₁₀=−78 mV)>Ru-400 (−52 mV)>Ru-200 (−21 mV)>Ru-300 (−12 mV). Again, Ru-300 stood out as the best among the series.

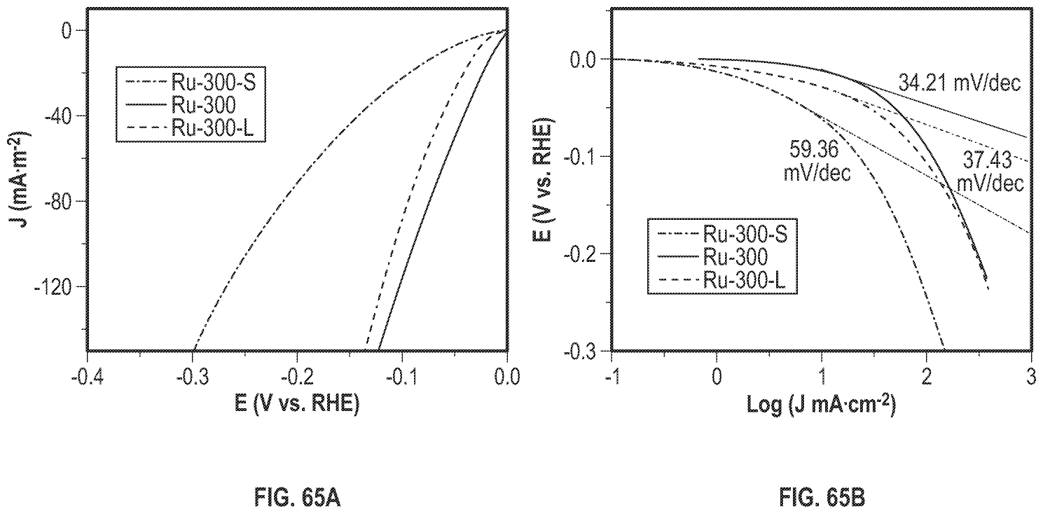

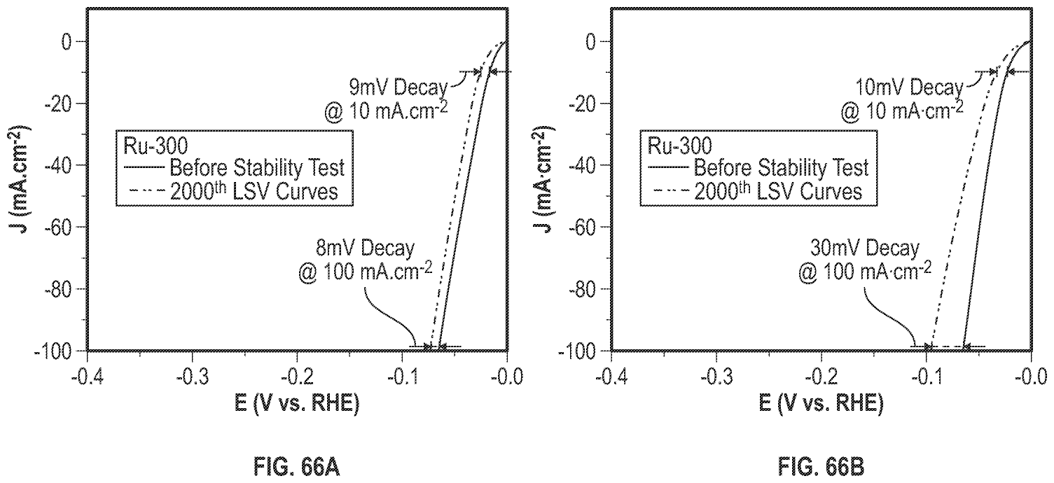

In the Tafel plots of FIG. 64, Ru-300 also showed a low slope of 34 mV dec⁻¹, comparable to that of Pt/C (n10=12 mV, 27 mV dec⁻¹), manifesting a Volmer-Tafel pathway. Other samples exhibited relatively slower kinetics, with a Tafel slope of 42, 52, and 59 mV dec⁻¹ for Ru-200, Ru-400, and Ru-600, respectively. As for Ru-300-L and Ru-300-S(FIGS. 65A-B), their η₁₀ values are −28 and −64 mV, along with a Tafel slope of 59 and 37 mV dec⁻¹, respectively. Taken together, these results indicate that Ru-300 represents the optimal catalyst within the present experimental context.

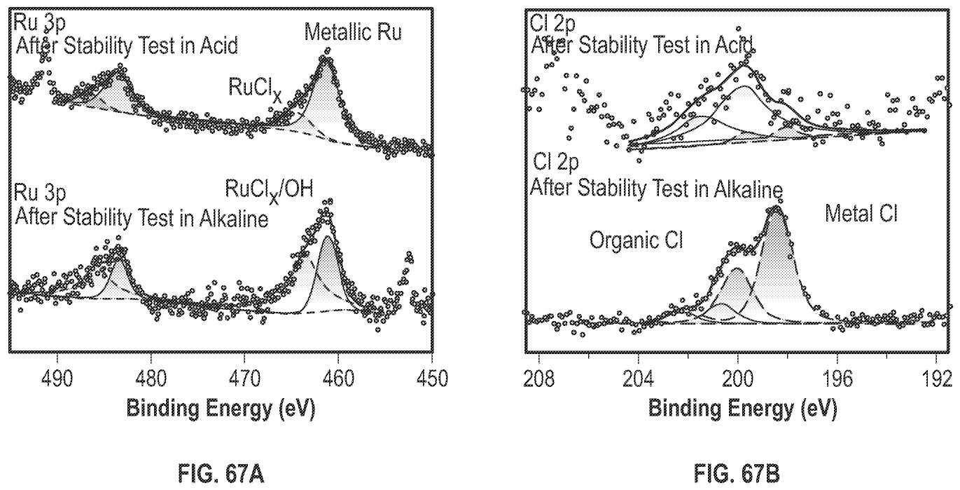

Ru-300 also exhibited excellent stability in both acidic and alkaline media. In accelerated LSV tests for 2,000 cycles (FIGS. 66A-B), one can see that η₁₀ in 0.5 M H₂SO₄ shifted negatively by only 10 mV and η₁₀₀ by 30 mV, whereas in 1 M KOH, the decay of the overpotential was much smaller, with a negative shift of only 9 mV for η₁₀ and 8 mV for η₁₀₀. This is consistent with results from XPS measurements (FIGS. 67A-B) where the Ru—Cl species remained well-defined in Ru-300 after the stability test in both 0.5 M H₂SO₄ (0.06%) and in 1 M KOH (0.72%), though at a somewhat reduced concentration as compared to that (0.96%) of the as-produced sample.

### Example 7

This Example describes theoretical and computational analysis of samples of Example 4.

First-principles computations were performed using Quantum ESPRESSO, an open-source plane-wave code. A 4×4-unit cell with 48 atoms was used to build a hexagonal Ru (10-11) slab supercell, where periodic image interactions were removed by setting a vacuum of 15 Å. Ru atoms of the bottom layer have been fixed during all relax calculations. A cutoff of 50 and 500 Ry for kinetics and charge density was chosen with the GBRV ultrasoft pseudopotential. The total energy of the Monkhorst-Pack 4×4×1 K-point grid in the supercell was calculated at the convergence level of 1 meV per atom. The smearing parameter was set at 0.01 Ry in the Marzari-Vanderbilt smearing for all calculations. For geometric relaxation, the convergence was 10⁻⁸ Ry of the electronic energy and 10⁻⁴ au for the total force. Density functional perturbation theory was employed to calculate the phonon frequency as inputs for entropy and zero-point energy.

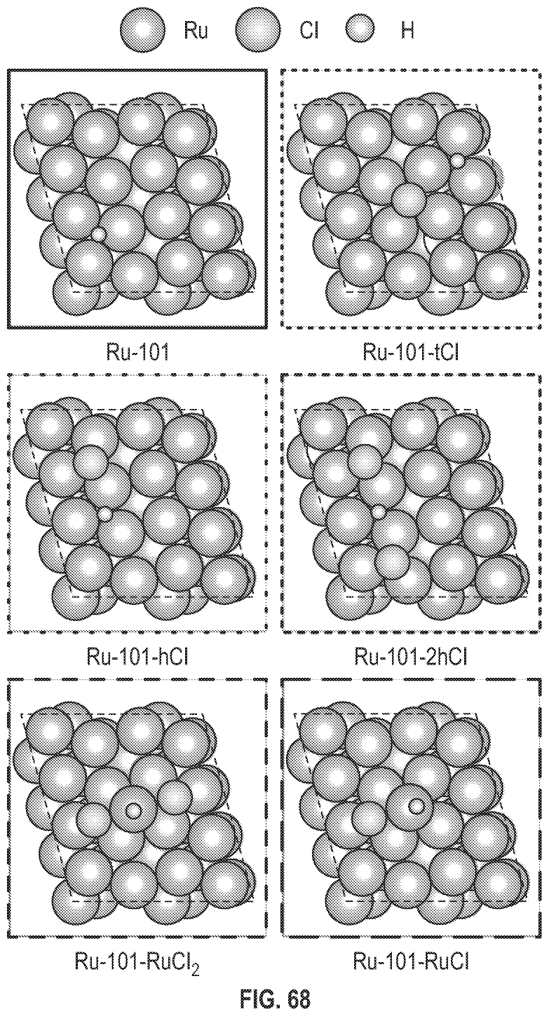

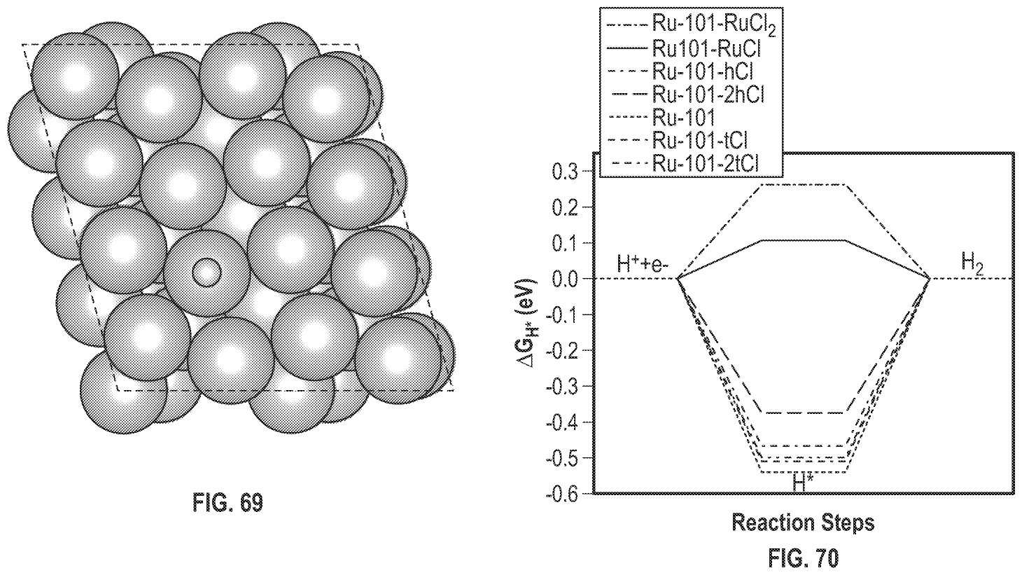

Based on the above experimental studies, it is believed that Ru—Cl species played an important role in the HER process. To understand the remarkable HER activity of Ru nanoparticles with surface-enriched Cl, DFT calculations were conducted to unravel the fundamental mechanism. As shown in FIG. 68, as (10-11) (i.e., (101)) is the main facet of hcp Ru, it was used to build the Cl-related models for H adsorption. The possibility of on-top adsorption of H on Ru-101 was tested as the input model (FIG. 69), but the model relaxed into the hollow-site adsorption (FIG. 68, left top frame, Ru-101), confirming that the on-top adsorption is subordinate to the hollow-fashion. This was further evidenced by the Gibbs free energy of H adsorption (ΔG_{H*}), as shown in FIG. 70, which has been widely used as a descriptor of the HER activity. Typically, a ΔG_{H*} close to 0 eV is the ideal condition for H to adsorb and desorb. In fact, H was favorably adsorbed on the hollow site of Ru-101 with a ΔG_{H*} of −0.54 eV, indicating that desorption of H from the surface would be energetically difficult.

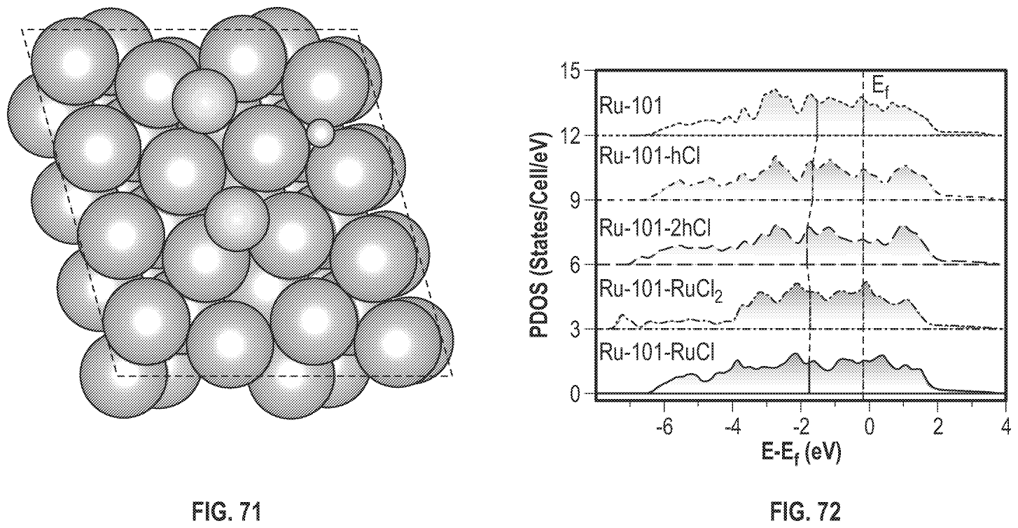

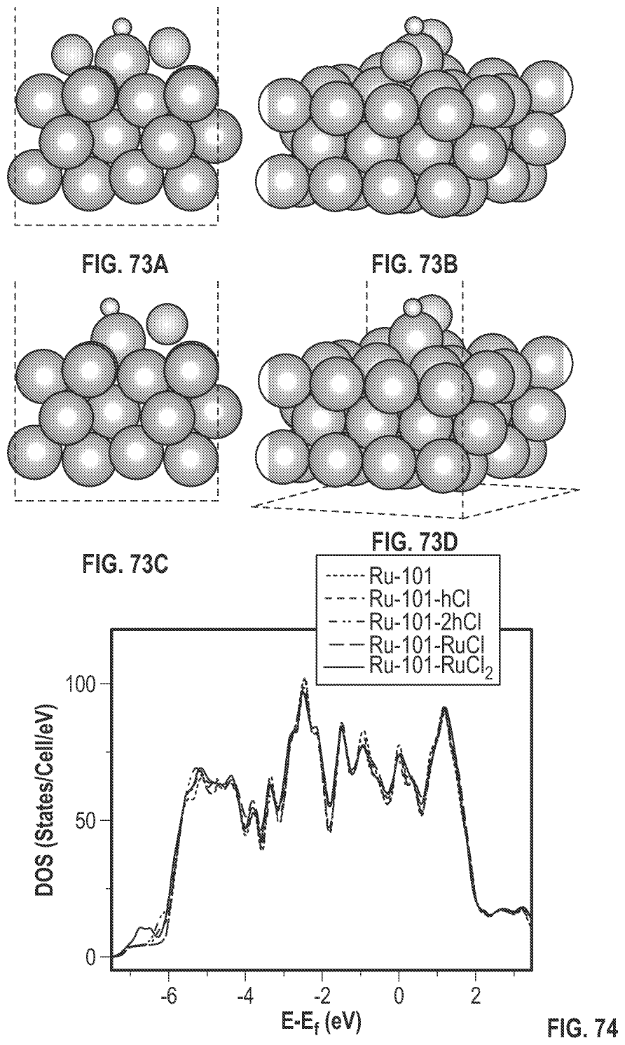

With Cl atom adsorbed on Ru-101 in a tetradentate fashion (Ru-101-tCl), it was found that the ΔG_{H*} slightly shifted to −0.51 eV. With two neighboring Cl (FIG. 71), ΔG_{H*} decreased further to −0.50 eV, implying that surface-adsorbed Cl indeed could facilitate the desorption of H from the Ru-101 surface. However, the effect remains too trivial. Considering that the interaction distance between Cl and H (3.7 Å) was still too far, a closer situation was then examined, where Cl was located at the hollow site of Ru-101 (Ru-101-hCl, left middle frame of FIG. 68), with a separation of 3.1 Å to the adsorbed H at the nearby hollow site. It was found that ΔG_{H*} decreased to −0.47 eV. If another Cl was added at the hollow site of Ru-101 (Ru-101-2hCl, right middle frame of FIG. 68), ΔG_{H*} now diminished to −0.38 eV, much improved for HER as compared to pristine Ru-101. Additional species of RuClₓ were also considered, including RuCl₂⁻ and RuCl²⁻, on the surface of the Ru slab by building models shown in FIG. 68 (bottom two frames) and FIGS. 73A-D. It was observed that with such an adatom mode, the H atom could stably adsorb onto the Ru atom in an on-top fashion, and a significant change was observed with ΔG_{H*}, i.e., +0.11 eV and +0.26 eV for Ru-101-RuCl and Ru-101-RuCl₂, respectively. This indicated that the RuClₓ species could indeed enhance the HER activity by weakening the H adsorption.

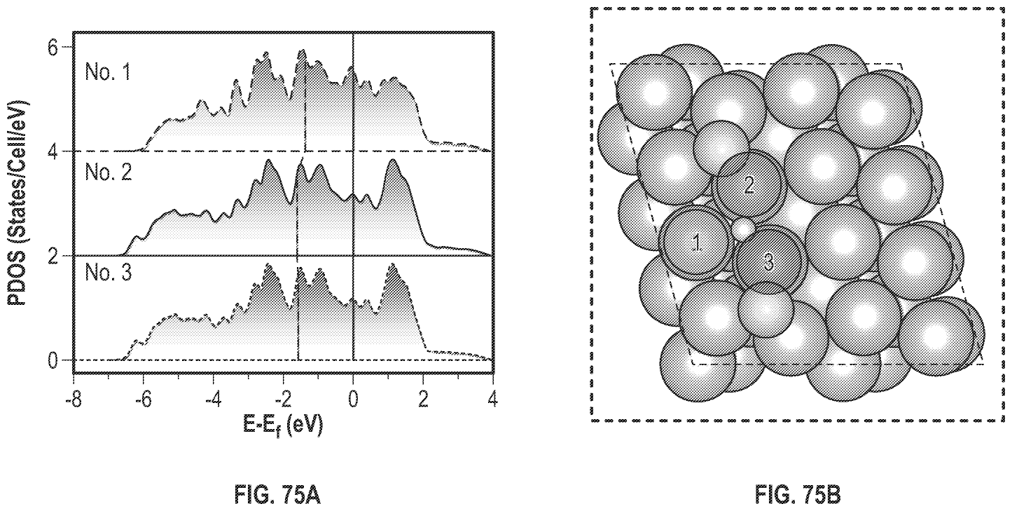

To further investigate the mechanism of weakened H adsorption, the total density of states (DOS) and partial density of states (PDOS) of the d electrons were calculated to determine the electronic structure of the bulk and the surface atoms. As can be seen in FIG. 74, the total DOS of several models with adsorbed Cl or RuClₓ species all have similar profiles, which denotes similar bulk electronic properties near the Fermi level, in agreement with the lack of significant difference amongst the Ru K-edge adsorption edges in XANES study (FIG. 58). Further analysis of PDOS of the Ru active sites in FIG. 68 showed the change of the d electrons, especially the d band centers (E_{d}). In comparison with surface Ru of Ru-101 where Ea was located at −1.33 eV, with the adsorption of even only one Cl, the neighboring Ru on Ru-101-hCl shifted negatively to −1.44 eV; and for Ru-101-2hCl (with the adsorption of two Cl's), the E_{d} downshifted further to −1.59 eV. Meanwhile, as depicted in FIGS. 75A-B, it can be seen that the Ea of Ru atoms without direct coordination with Cl also shifted slightly to −1.40 eV, signifying that adsorption of Cl atoms had a strong impact on the local electronic structure. Furthermore, both Ru-101-RuCl and Ru-101-RuCl₂ were observed to exhibit a downshift of Ea to −1.52 and −1.50 eV, respectively (FIG. 72), significantly different from the Ru-101.

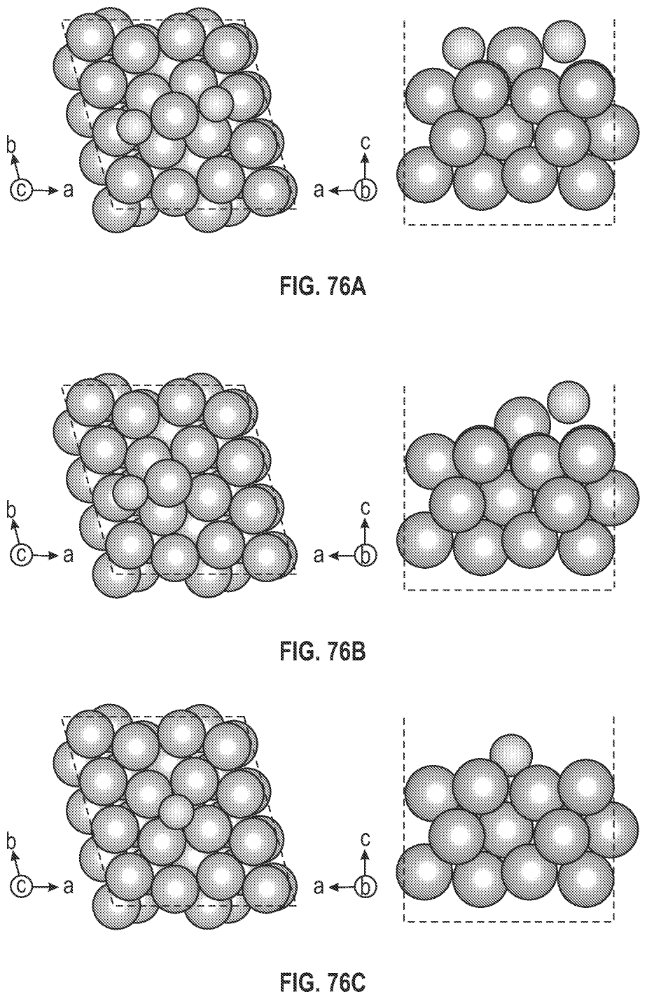

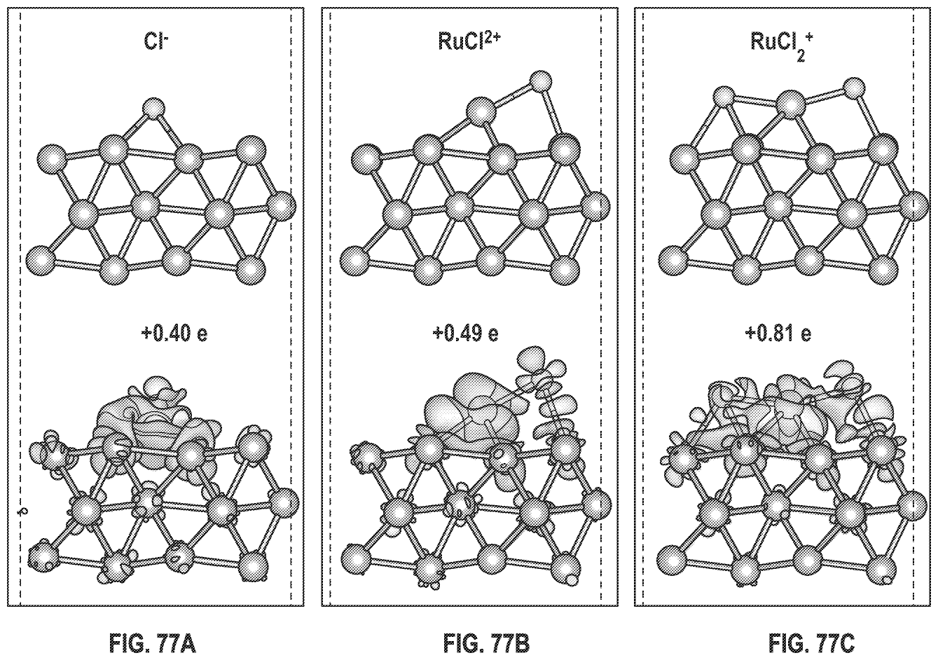

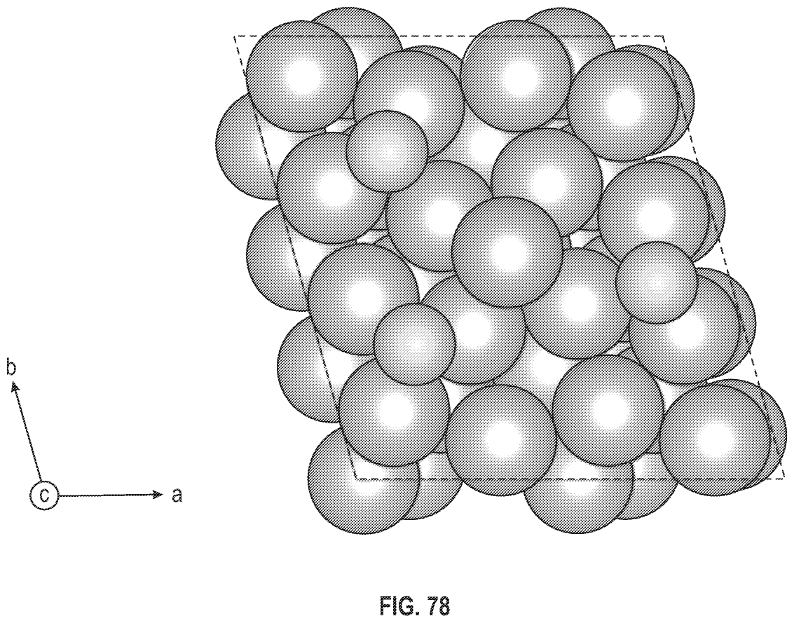

Further insights into the interactions between Ru nanoparticles and RuClₓ or Cl ligands were obtained by Bader charge analysis, as shown in FIGS. 76A-C and 77A-C. A hcp Ru (10-11) slab was built with surface adsorption of Cl⁻, RuCl₂⁺, and RuCl₂⁺ species to represent the incomplete decomposition of RuCl₃. It should be noted that RuCl₃ would spontaneously decompose into Cl⁻ and Ru atoms on the Ru slab (FIG. 78). Significantly, one can see that efficient charge transfer occurred from the Ru slab to these Cl species (FIGS. 77A-C). For one adsorbed Cl⁻, it could withdraw 0.40 electron from the Ru slab, and 0.49 and 0.81 electrons from the Ru slab to RuCl²⁺ and RuCl₂⁺, respectively. Thus, such interfacial charge transfer was responsible for the downshift of E_{d} and weakened adsorption of H on the Ru nanoparticle surface, leading to enhanced HER activity, as observed experimentally.

In summary, magnetic induction heating was exploited for the ultrafast and green (i.e., environmentally friendly) preparation of Ru nanoparticles supported on carbon paper. The samples could be prepared within seconds, and the rapid synthesis led to the formation of metal Cl species on the Ru nanoparticle surface. With this unique structural feature, the samples all exhibited apparent electrocatalytic activity towards HER in both acidic and alkaline media, and the best sample, Ru-300 needed a respective overpotential of only −23 and −12 mV to reach 10 mA cm⁻², rivaling commercial Pt/C benchmark, along with excellent stability. Results from DFT calculations showed that the surface Cl species induced apparent electron transfer from the Ru nanoparticles, rendering the downshift of the Ru Ea and hence weakened H adsorption, a unique feature for enhanced HER activity, as observed experimentally. Results from the Examples of this disclosure highlight the unique significance of MIHRQ in the structural engineering of metal nanoparticles by heteroanion functionalization for enhancement of their electrocatalytic performance.

It will be appreciated that of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, or material.

What is claimed is:

1. A method for making a catalyst composition, the method comprising:
placing a substrate with at least one precursor composition disposed thereon in contact with a ferromagnetic material;
placing the substrate and the ferromagnetic material within an induction solenoid;
generating an alternating magnetic field within the induction solenoid upon energization by a power source supplying alternating current, thereby heating the substrate and the ferromagnetic material to a temperature of from about 200° C. to about 1,500° C.; and
rapidly cooling the substrate and the ferromagnetic material.

2. The method according to claim 1, wherein rapidly cooling includes submerging the substrate and the ferromagnetic material in a liquid having a temperature of from about −50° C. to about −100° C.

3. The method according to claim 2, wherein the liquid includes an alcohol and dry ice.

4. The method according to claim 1, wherein the at least one precursor composition includes a solution comprised of a nickel salt and iron salt.

5. The method according to claim 4, wherein the nickel salt is nickel chloride and the iron salt is iron chloride.

6. The method according to claim 1, wherein the substrate is a carbon paper.

7. The method according to claim 1, wherein the ferromagnetic material is an iron sheet.

8. The method according to claim 1, wherein the substrate with the at least one precursor composition is disposed between two sheets of the ferromagnetic material.

9. The method according to claim 1, wherein the alternating current is from about 200 amps to about 600 amps.

10. The method according to claim 1, wherein the alternating current is about 300 amps.

11. The method according to claim 1, wherein the alternating current is supplied from about 3 seconds to about 12 seconds.

12. The method according to claim 1, wherein the alternating current is supplied for about 6 seconds.

13. The method according to claim 1, wherein the precursor composition includes a ruthenium halide salt.

14. The method according to claim 13, wherein the ruthenium halide salt is ruthenium (III) chloride.

15. The method according to claim 14, wherein rapidly cooling forms a plurality of nanoparticles including ruthenium and a chloride-rich surface.

16. The method according to claim 1, wherein rapidly cooling forms a plurality of nanoparticles including the ferromagnetic material and at least one heteroanion.

17. A catalyst composition comprising:
a plurality of nanoparticles disposed on a carbon substrate, the plurality of nanoparticles including at least one ferromagnetic material and at least one heteroanion.

18. The catalyst composition according to claim 17, wherein the plurality of nanoparticles have an average particle diameter from about 20 nm to about 100 nm.

19. The catalyst composition according to claim 17, wherein the heteroanion is chloride.

20. The catalyst composition according to claim 19, wherein the at least one heteroanion is present in an amount from about 1% to about 15% by weight of the catalyst composition.

21. The catalyst composition according to claim 20, further comprising a plurality of nanospindles.

22. The catalyst composition according to claim 21, wherein the plurality of nanospindles include a higher amount of chloride than the plurality of nanoparticles.

23. The catalyst composition according to claim 19, wherein the at least one ferromagnetic material includes iron and nickel.

24. The catalyst composition according to claim 23, wherein the plurality of nanoparticles are spinels including oxygen.

25. The catalyst composition according to claim 24, wherein the spinels have a formula of Fe₃₋ₓNiₓO₄.

26. A catalyst composition comprising:
a plurality of nanoparticles disposed on a carbon substrate, the plurality of nanoparticles including ruthenium and at least one heteroanion.

27. The catalyst composition according to claim 26, wherein the plurality of nanoparticles has an average particle diameter from about 2 nm to about 10 nm.

28. The catalyst composition according to claim 26, wherein the at least one heteroanion is chloride.

29. The catalyst composition according to claim 28, wherein the at least one heteroanion is present in an amount from about 1% to about 15% by weight of the catalyst composition.

30. The catalyst composition according to claim 28, wherein the at least one heteroanion is primarily disposed on a surface of the plurality of nanoparticles.

31. The catalyst composition according to claim 28, having an HER overpotential of about −23 mV to reach 10 mA cm⁻² in an acidic medium.

32. The catalyst composition according to claim 28, having an HER overpotential of about −12 mV to reach 10 mA cm⁻² in an alkaline medium.
